(19) United States
(12) Patent Application Publication
(10) Pub. No.: US 2019/0124165 A1
(43) Pub. Date: Apr. 25, 2019

(54) SYSTEM AND METHOD FOR DIGITAL WAYFINDING

(71) Applicant: Southwest Airlines Co., Dallas, TX (US)

(72) Inventors: Justin Bundick, Dallas, TX (US); Heather Figallo, Dallas, TX (US); Kevin Kleist, Dallas, TX (US); Tim Pilson, Dallas, TX (US); Tony Roach, Dallas, TX (US)

(21) Appl. No.: 16/168,553

(22) Filed: Oct. 23, 2018

Related U.S. Application Data
(60) Provisional application No. 62/575,994, filed on Oct. 23, 2017.

(51) Int. Cl. H04L 29/08; H04W 4/40; G06F 3/0482; H04W 68/00

(52) U.S. Cl. CPC H04L 67/18; H04W 68/005; G06F 3/0482; H04W 4/40

(57) ABSTRACT

An electronic device including a computing system is provided. The computing system includes a memory and at least one processor. The computing system is configured to receive travel information of a user account associated with the electronic device. The travel information includes one or more scheduled travel times. The computing system is also configured to determine a location of the electronic device. The computing system is further configured to determine a duration of time between a current time and the one or more scheduled travel times. In addition, the computing system is configured to generate, for display on a display screen associated with the electronic device, one or more travel notifications based on the location of the electronic device, the duration of time, and the travel information.

### CROSS-REFERENCE TO RELATED APPLICATION AND PRIORITY CLAIM

This Application claims priority under 35 U.S.C. § 119(e) to U.S. Provisional Patent Application No. 62/575,994 filed on Oct. 23, 2017 and entitled “SYSTEM AND METHOD FOR DIGITAL WAYFINDING.” The above-identified provisional patent application is hereby incorporated by reference in its entirety.

### TECHNICAL FIELD

The present disclosure relates to digital wayfinding. More specifically, this disclosure relates to a system and method for digital wayfinding in transport hubs.

### BACKGROUND

Navigating transport hubs for an individual often requires that the individual have up-to-date information regarding travel arrangements. For example, in an airport, gate changes for planes are common, and a gate listed on a ticket in the possession of a passenger may not be correct when the passenger is attempting to locate the proper gate for boarding. This requires the passenger to search for gate information that may be posted on a notice board somewhere in the airport, which might cause the passenger to journey away from the correct gate to find this information. The passenger may then have to scan the board to find the flight among numerous other listed flights, which can also waste time. Time spent searching for travel information may even cause the passenger to miss a flight. The passenger may also need other information not readily available, such as amenities available on a particular flight, flight connections, or other information.

### SUMMARY

This disclosure provides systems, methods, and apparatuses for performing digital wayfinding operations as described herein.

In a first embodiment, the disclosure provides an electronic device including a computing system. The computing system includes a memory and at least one processor. The computing system is configured to receive travel information of a user account associated with the electronic device. The travel information includes one or more scheduled travel times. The computing system is also configured to determine a location of the electronic device. The computing system is further configured to determine a duration of time between a current time and the one or more scheduled travel times. In addition, the computing system is configured to generate, for display on a display screen associated with the electronic device, one or more travel notifications based on the location of the electronic device, the duration of time, and the travel information.

In a second embodiment, the disclosure provides a method implemented by a computing system of an electronic device. The method includes receiving, by the computing system, travel information of a user account associated with the electronic device. The travel information includes one or more scheduled travel times. The method also includes determining, by the computing system, a location of the electronic device. The method further includes determining, by the computing system, a duration of time between a current time and the one or more scheduled travel times. In addition, the method includes generating, by the computing system for display on a display screen associated with the electronic device, one or more travel notifications based on the location of the electronic device, the duration of time, and the travel information.

In a third embodiment, the disclosure provides a non-transitory, computer-readable storage medium. The non-transitory, computer-readable storage medium stores one or more executable instructions that, when executed by at least one processor of an electronic device, cause the at least one processor to receive travel information of a user account associated with the electronic device. The travel information includes one or more scheduled travel times. The one or more executable instructions that, when executed by at least one processor, also cause the at least one processor to determine a location of the electronic device. The one or more executable instructions that, when executed by at least one processor, further cause the at least one processor to determine a duration of time between a current time and the one or more scheduled travel times. In addition, the one or more executable instructions that, when executed by at least one processor, cause the at least one processor to generate, for display on a display screen associated with the electronic device, one or more travel notifications based on the location of the electronic device, the duration of time, and the travel information.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication (e.g. electronic communication) between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable storage medium. The terms “application” and “program” refer to one or more computer programs, software components, sets of instructions, procedures, functions, objects, classes, instances, related data, or a portion thereof adapted for implementation in a suitable computer readable program code. The phrases “computer readable program code” and “executable instruction” includes any type of computer code, including source code, object code, and executable code. The phrase “computer readable medium” and “computer-readable storage medium” includes any type of medium capable of being accessed by a computer or a processor, such as read only memory (ROM), random access memory (RAM), a hard disk drive, a compact disc (CD), a digital video disc (DVD), or any other type of memory. A “non-transitory” computer-readable medium and a “non-transitory” computer-readable storage medium exclude wired, wireless, optical, or other communication links that transport transitory electrical or other signals. A non-transitory, computer-readable medium and a non-transitory, computer-readable storage medium include media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates a non-limiting, example network context for operating an electronic device according to certain embodiments of this disclosure;

FIG. 2 illustrates a non-limiting, example digital wayfinding system according to certain embodiments of this disclosure;

FIG. 3 illustrates a non-limiting, example computing system configured for digital wayfinding operations according to certain embodiments of this disclosure;

FIGS. 4A, 4B, 4C, and 4D illustrate non-limiting, example user interface displays according to certain embodiments of this disclosure;

FIG. 5 illustrates a non-limiting, example user interface menu display according to certain embodiments of this disclosure;

FIG. 6 illustrates a non-limiting, example user interface home display according to certain embodiments of this disclosure;

FIG. 7 illustrates a non-limiting, example user interface notification display according to certain embodiments of this disclosure;

FIG. 8 illustrates a non-limiting, example user interface customer service communication display according to certain embodiments of this disclosure;

FIG. 9 illustrates a non-limiting, example user interface pictorial display according to certain embodiments of this disclosure;

FIGS. 10, 11, 12, and 13 illustrate a non-limiting, example user interface map display according to certain embodiments of this disclosure;

FIG. 14 illustrates a non-limiting, example user interface social media display according to certain embodiments of this disclosure;

FIG. 15 illustrates another non-limiting, example user interface notification display according to certain embodiments of this disclosure;

FIGS. 16, 17, 18, and 19 illustrate non-limiting, example methods for performing one or more digital wayfinding operations according to certain embodiments of this disclosure;

FIG. 20 illustrates a non-limiting, example device supporting the depiction and usage of one logical connection with a collection of input/output (I/O) modules as multiple individual logical connections according to certain embodiments of this disclosure;

FIG. 21 illustrates a non-limiting, example mobile device according to certain embodiments of this disclosure; and

FIG. 22 illustrates a non-limiting, example computer system configured to implement aspects of apparatuses, systems, and methods according to certain embodiments of this disclosure.

### DETAILED DESCRIPTION

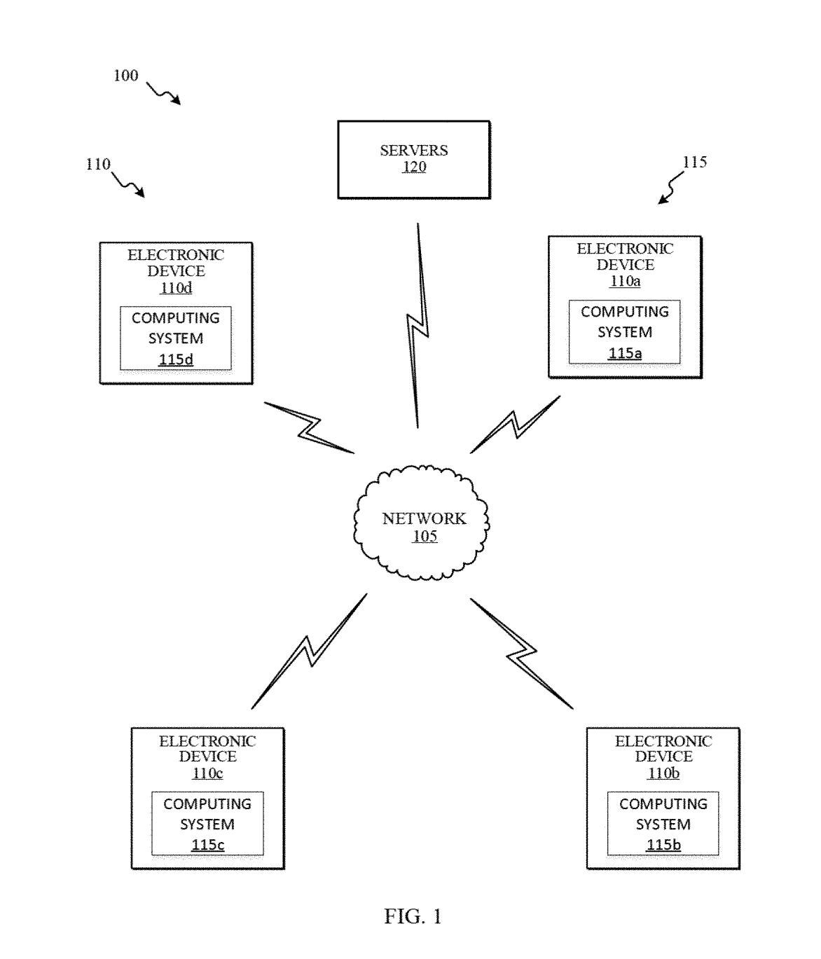

FIGS. 1 through 22, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

FIG. 1 illustrates a non-limiting, example network context 100 for operating one or more electronic devices 110 according to certain embodiments of this disclosure. One or more components of the network context 100 may operate as separate components linked by one or more constituent networks of the network 105. In some embodiments, one or more constituent networks of the network 105 may include the internet, which can be accessed over both wired connections (e.g., an Ethernet connection) or over a wireless connection (e.g., a wireless local area network “WLAN” connection, a cellular network connection). Additionally, or alternatively, one or more constituent networks of the network 105 may include a combination of private networks (e.g., a local wireless mesh network) and public networks (e.g., a telephone (POTS) network). In certain embodiments, one or more constituent networks of the network 105 may support multiple communication protocols, including both wireless protocols (e.g., BLUETOOTH™, circuit-switched cellular, 3G, LTE, WiBro) and internet protocols (e.g., HTTP).

The one or more constituent networks of the network 105 provide two-way electronic connectivity and electronic communication between each of the electronic devices 110 and the one or more servers 120. In certain embodiments, the one or more constituent networks of the network 105 provide two-way electronic connectivity and electronic communication between each of the electronic devices 110 and the one or more servers 120 using one or more same or different channels, protocols, or networks of network 105. For example, a circuit-switched cellular protocol wireless network of the network 105 provides electronic connectivity and electronic communication between the first electronic device 110a and the one or more servers 120 while a POTS wireless network of the network 105 provides electronic connectivity and electronic communication between the third electronic device 110c and the one or more servers 120.

In certain embodiments, the network context 100 may, according to certain embodiments, include one or more servers 120. In certain embodiments, the one or more servers 120 receive and store a plurality of user accounts (e.g., user profiles). Each user account may include user account information. User account information may include at least one of one or more user identifications (ID) (e.g., a person's name, a rapid rewards number, a user travel code), one or more stored passwords, a user status (e.g., a rapid rewards member), one or more user preferences (e.g., a travel preference, a dietary preferences, a shopping preference, a boarding preference), one or more transportation identifications identifying one or more transportation activities associated with a user of the user account. For example, user account information of a user account may include a transportation identification identifying an airplane flight that a user associated with the user account previously took. As another example, user account information of a user account may include a transportation identification identifying an airplane flight that a user associated with the user account is scheduled to take in the future.

The one or more servers 120 may also receive and store transportation information related to each of one or more transportation activities. For example, the one or more servers 120 may receive and store transportation information regarding one or more airplane flights operated by one or more specific operator services. For each transportation activity, transportation information may include at least one of a transportation identification (e.g., a flight number), a departure date, a departure time, a departure facility (e.g., a departure airport), a departure terminal, a departure gate, a travel time, an arrival date, an arrival time, an arrival facility (e.g., an arrival airport), an arrival terminal, an arrival gate, a baggage pick-up location at an arrival facility, a transport vehicle status (e.g., an airplane is in flight or in transit to a departure facility or a departure gate, an airplane has not departed for a departure facility, an airplane has arrived at a departure facility and is taxiing to a departure gate, an airplane has arrived at a departure gate, an airplane has arrived at a departure gate and passengers are deplaning, an airplane has arrived at a departure gate and the airplane is being serviced for departure, an airplane has arrived at a departure gate and the airplane is being boarded by passengers for departure, an airplane has arrived at a departure gate and has pushed away from the gate for departure), or the like. It should be understood that while the examples provided herein are directed to airplane travel, the disclosure is not limited to airplane travel. For example, a transportation activity may include helicopter travel, bus travel, automobile travel, train travel, bicycle travel, trolley travel, subway train travel, gondola travel, or the like.

The one or more servers 120 may also receive and store commuting information associated with human transportation mechanisms surrounding one or more departure facilities. For example, the one or more servers 120 may receive and store current information related to automobile traffic flow on one or more roads or freeways surrounding or within a distance from one or more departure facilities you. As another example, the one or more servers may receive and store current information related to one or more train schedules providing transportation around into a departure facility.

In certain embodiments, the one or more servers 120 may receive and store departure facility traffic information. For example, the one or more servers 120 may receive an indication of an occupancy of one or more parking lots servicing a departure facility. As another example, the one or more servers may receive an indication of a wait time at one or more security checkpoints at a departure facility. In certain embodiments, the one or more servers 120 may receive and store departure facility information. For example, the one or more servers 120 may receive and store one or more departure facility maps of one or more departure facilities. The one or more departure facility maps may indicate human traffic pathways, terminals, gates, baggage claims, and customer service centers. As another example, the one or more servers 120 may receive and store a list of one or more restaurants, shops, and kiosks located at one or more departure facilities. As another example, the one or more servers 120 may receive and store departure facility maps of one or more departures facilities indicating locations of one or more restaurants, shops, and kiosks.

The one or more servers 120 may generate and transmit travel information of a user account associated with an electronic device 110. In certain embodiments, the one or more servers 120 may generate travel information based on at least one of one or more items of user account information, one or more items of transportation information, one or more items of commuting information, one or more items of departure facility traffic information, or one or more items of departure facility information. For example, after the one or more servers 120 receive at least one of one or more items of user account information, one or more items of transportation information, one or more items of commuting information, one or more items of departure facility traffic information, or one or more items of departure facility information, the one or more servers 120 may identify an electronic device 110 associated with the user account. The one or more servers 120 may generate travel information associated with the user account based on at least one of one or more items of user account information, one or more items of transportation information, one or more items of commuting information, one or more items of departure facility traffic information, or one or more items of departure facility information. The one or more servers 120 may transmit the travel information of the user account to the electronic device 110 so that the electronic device 110 performs one or more digital wayfinding operations. In certain embodiments, the one or more servers 120 may transmit the travel information of the user account and including one or more scheduled travel times to the electronic device 110 so that the electronic device 110 performs one or more digital wayfinding operations.

In certain embodiments, the network context 100 includes one or more electronic devices 110. The one or more electronic devices 110 may include a first electronic device 110a, a second electronic device 110b, a third electronic device 110c, and a fourth electronic device 110d. In certain embodiments, each of the one or more electronic devices 110 is configured to communicate data with the one or more servers 120 through the network 105. In certain embodiments, each of the one or more electronic devices 110 are configured to execute one or more digital wayfinding operations. In certain embodiments, each of the electronic devices 110 includes an electronic device display screen, an electronic device memory, and at least one electronic device processor. The electronic devices 110 may be any of various types of devices, including, but not limited to, a computer embedded in an appliance, a personal computer system, a desktop computer, a handset, a laptop computer, a notebook computer, a tablet, a slate, a netbook computer, a handheld computer, a consumer device, a portable storage device, a mainframe computer system, a workstation, network computer, a mobile device, a storage device, a peripheral device such as a switch, modem, router, or in general any type of electronic computing device.

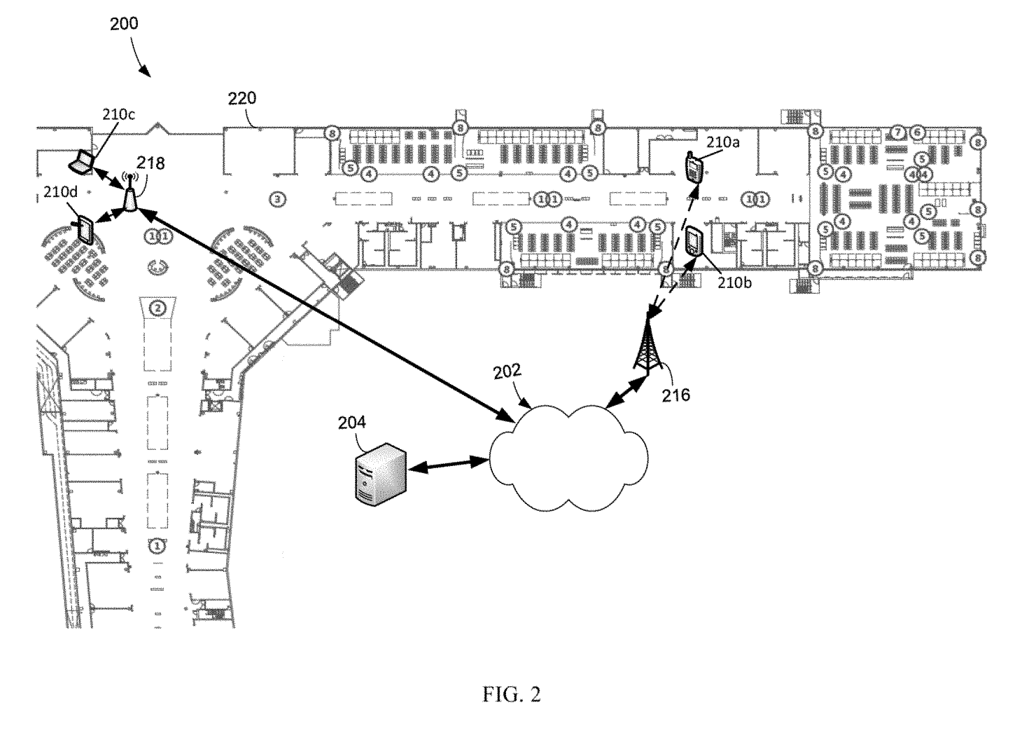

FIG. 2 illustrates a non-limiting, example digital wayfinding system 200 according to certain embodiments of this disclosure. The embodiment of the digital wayfinding system 200 shown in FIG. 2 is for illustration only. Other embodiments of the digital wayfinding system 200 could be used without departing from the scope of this disclosure. For example, one or more components from the network context 100 illustrated in FIG. 1 may be included into the digital wayfinding system 200 or may be the same as or at least similar to one or more components of the digital wayfinding system 200. As another example, one or more components from the digital wayfinding system 200 may be included into the network context 100 illustrated in FIG. 1 or may be the same as or at least similar to one or more components of the network context 100 illustrated in FIG. 1.

As shown in FIG. 2, the digital wayfinding system 200 includes a network 202, which facilitates communication between various components in the digital wayfinding system 200. For example, the network 202 may communicate internet protocol (IP) packets, frame relay frames, asynchronous transfer mode (ATM) cells, or other information between network addresses. The network 202 may include one or more local area networks (LANs), metropolitan area networks (MANs), wide area networks (WANs), all or a portion of a global network such as the Internet, or any other communication system or systems at one or more locations. The network 202 may be the same as or at least similar to the network 105 illustrated in FIG. 1.

The network 202 facilitates communications between a server 204 and various mobile devices 210a, 210b, 210c, and 210d. The server 204 may be the same as or at least similar to the one or more servers 120 illustrated in FIG. 1. Each server 204 includes any suitable computing or processing device that can provide computing services for one or more mobile devices. Each server 104 could, for example, include one or more processing devices, one or more memories storing instructions and data, and one or more network interfaces facilitating communication over the network 202.

Each mobile device 210a, 210b, 210c, and 210d represents any suitable computing or processing device that interacts with at least one server or other computing device(s) over the network 202. In this example, the mobile devices 210a, 210b, 210c, and 210d include a mobile telephone or smartphone 210a, a personal digital assistant (PDA) 210b, a laptop computer 210c, and a tablet computer 210d. However, any other or additional mobile devices could be used in the digital wayfinding system 200. For example, the mobile devices 210a, 210b, 210c, and 210d may be the same as or at least similar to the electronic devices 110a, 110b, 110c, and 110d illustrated in FIG. 1.

In this example, at least some of the mobile devices 210a, 210b, 210c, and 210d communicate indirectly with the network 202. For example, the mobile devices 210a, 210b, 210c, and 210d may communicate via one or more base stations 216, such as cellular base stations or eNodeBs. Also, the mobile devices 210a, 210b, 210c, and 210d may communicate via one or more wireless access points 218, such as IEEE 802.11 wireless access points. Note that these are for illustration only and that each mobile device could communicate directly with the network 202 or indirectly with the network 202 via any suitable intermediate device(s) or network(s).

The digital wayfinding system 200 further includes a transportation hub 220. The mobile devices 210a, 210b, 210c, and 210d may be present within the transportation hub 220 while accessing a server 204 to provide digital wayfinding services to the mobile devices 210a, 210b, 210c, and 210d. Additionally, nodes 1-8 within the transportation hub 220 may provide additional information to users and additional functionality to the mobile devices 210a, 210b, 210c, and 210d. Such additional functionality may be provided using a geo-location of one of the mobile devices 210a, 210b, 210c, and 210d. For example, when one of the mobile devices 210a, 210b, 210c, and 210d is within the transportation hub 220, information regarding travel arrangements may begin being displayed on a display screen of one of the mobile devices 210a, 210b, 210c, and 210d.

When one of the mobile devices 210a, 210b, 210c, and 210d is in close proximity to one of the nodes 1-8 information may be displayed either on the mobile device or on the node in close proximity, the information being tailored to travel arrangements concerning the user of the mobile device. The nodes 1-8 include a flight display 1, a network display 2, a gate display 3, a gate information display 4, a gate/arrival display 5, a kiosk 6, a pillar 7, and jetway display 8.

Although FIG. 2 illustrates one example of digital wayfinding system 200, various changes may be made to FIG. 2. For example, the digital wayfinding system 200 could include any number of each component in any suitable arrangement. In general, computing and communication systems, such as the digital wayfinding system 200, come in a wide variety of configurations, and FIG. 2 does not limit the scope of this disclosure to any particular configuration. While FIG. 2 illustrates one operational environment in which various features disclosed in this patent document can be used, these features could be used in any other suitable system.

Returning to FIG. 1, as described herein, the network context 100 may include one or more electronic devices 110. The one or more electronic devices 110 may be the same as or at least similar to the mobile devices 210a, 210b, 210c, and 210d illustrated in FIG. 2. In certain embodiments, each of the one or more electronic devices 110 includes a computing system 115. For example, the first electronic device 110a includes a first computing system 115a, the second electronic device 110b includes a second computing system 115b, the third electronic device 110c includes a third computing system 115c, and the fourth electronic device 110d includes a fourth computing system 115d. Each of the computing systems 115 may include an electronic device memory and at least one electronic device processor to execute one or more digital wayfinding operations described herein.

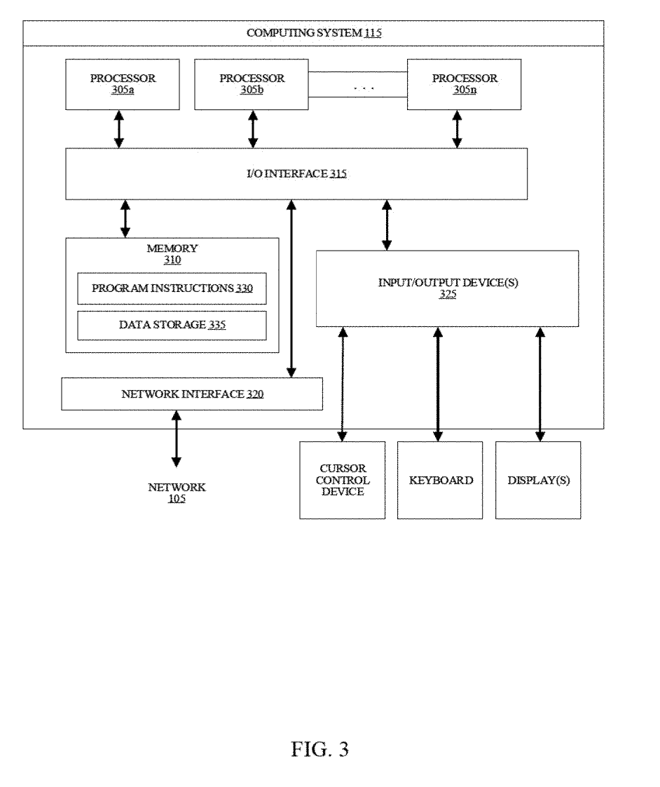

FIG. 3 illustrates a non-limiting, example of the computing system 115 illustrated in FIG. 1. The computing system 115 is configured to execute any and all of the embodiments and operations described herein including embodiments for performing one or more digital wayfinding operations. In certain embodiments, the computing system 115 may perform one or more digital wayfinding operations using at least one of the network 105 or a user input interface to receive travel information of a user account associated with the electronic device, the travel information including one or more scheduled travel times, determine a location of the electronic device, determine a duration of time between a current time and the one or more scheduled travel times, and generate, for display on a display screen associated with the electronic device, one or more travel notifications based on the location of the electronic device, the duration of time, and the travel information. In different embodiments, the computing system 115 may be any of various types of devices, including, but not limited to, a computer embedded in an appliance, a personal computer system, a desktop computer, a handset, a laptop computer, a notebook computer, a tablet, a slate, a netbook computer, a handheld computer, a consumer device, a portable storage device, a mainframe computer system, a workstation, network computer, a mobile device, an application server, a storage device, a peripheral device such as a switch, modem, router, or in general any type of electronic computing device.

Various embodiments of a system and method for digital wayfinding operations, as described herein, may be executed on one or more computing systems 115, which may interact with various other devices. In the illustrated embodiment, the computing system 115 may include one or more processors 305a, 305b, . . . , and 305n (hereinafter “one or more processors 305,” “processors 305,” or “processor 305”) coupled to a memory 310 via an input/output (I/O) interface 315. The computing system 115 may further include a network interface 320 coupled to I/O interface 315, and one or more input/output devices 325, such as cursor control device of the electronic device 110, a keyboard of the electronic device 110, and one or more displays of the electronic device 110. In some cases, it is contemplated that embodiments may be implemented using a single instance of the computing system 115, while in other embodiments multiple such systems, or multiple nodes making up the computing system 115, may be configured to host different portions or instances of embodiments. For example, in one embodiment some elements may be implemented via one or more nodes of the computing system 115 that are distinct from those nodes implementing other elements.

In various embodiments, the computing system 115 may be a uniprocessor system including one processor 305a, or a multiprocessor system including several processors 305a-305n (e.g., two, four, five, eight, or another suitable number). The processor 305 may be any suitable processor capable of executing instructions or operations including digital wayfinding operations as described herein. For example, in various embodiments the processor 305 may be general-purpose or embedded processors implementing any of a variety of instruction set architectures (ISAs), such as the x86, PowerPC, SPARC, or MIPS ISAs, or any other suitable ISA. In multiprocessor systems, each of processors 305 may commonly, but not necessarily, implement the same ISA.

The memory 310 may be configured to store the executable instructions or program instructions 330 in the data storage 335 accessible by the processor 305. In various embodiments, the memory 310 may be implemented using any suitable memory technology, such as static random access memory (SRAM), synchronous dynamic RAM (SDRAM), nonvolatile/Flash-type memory, or any other type of memory. In the illustrated embodiment, the program instructions 330 may be configured to implement a system for performing digital wayfinding operations incorporating any of the functionality, as described herein. In some embodiments, program instructions 330 or data may be received, sent, or stored upon different types of computer-accessible media or on similar media separate from the memory 310 or the computing system 115. The computing system 115 is described as implementing at least some of the functionality of functional blocks in the figures described herein.

In certain embodiments, the I/O interface 315 may be configured to coordinate I/O traffic between the processor 305, the memory 310, and any peripheral devices in the computing system 115, including the network interface 320 or other peripheral interfaces, such as the input/output devices 325. In some embodiments, the I/O interface 315 may perform any necessary protocol, timing or other data transformations to convert data signals from one component (e.g., the memory 310) into a format suitable for use by another component (e.g., the processor 305). In some embodiments, the I/O interface 315 may include support for devices attached through various types of peripheral buses, such as a variant of the Peripheral Component Interconnect (PCI) bus standard or the Universal Serial Bus (USB) standard, for example. In some embodiments, the function of the I/O interface 315 may be split into two or more separate components, such as a north bridge and a south bridge, for example. Also, in some embodiments some or all of the functionality of the I/O interface 315, such as an interface to the memory 310, may be incorporated directly into the processor 305.

The network interface 320 may be configured to allow data to be exchanged between the computing system 115 and other devices attached to the network 105 (e.g., one or more servers 120) or between nodes of the computing system 115. The network 105 may in various embodiments include one or more networks including but not limited to Local Area Networks (LANs) (e.g., an Ethernet or corporate network), Wide Area Networks (WANs) (e.g., the Internet), wireless data networks, some other electronic data network, a combination thereof, or the like. In various embodiments, the network interface 320 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network or protocol.

The input/output devices 325 may, in some embodiments, include one or more display terminals, keyboards, keypads, touchpads, scanning devices, voice, or optical recognition devices, or any other devices suitable for entering or accessing data by one or more computing systems 115. Further, various other sensors may be included in the I/O devices 325, such as imaging sensors, barometers, altimeters, LIDAR, or any suitable environmental sensor. Multiple input/output devices 325 may be present in the computing system 115 or may be distributed on various nodes of the computing system 115. In some embodiments, similar input/output devices may be separate from the computing system 115 and may interact with one or more nodes of the computing system 115 through a wired or wireless connection, such as over the network interface 320.

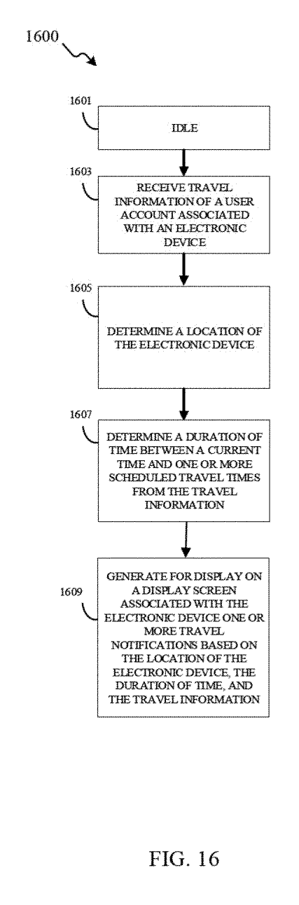

As shown in FIG. 3, the memory 310 may include program instructions 330, which may be processor-executable to implement any element, action, or operation including digital wayfinding operations, as described herein. In certain embodiment, the program instructions 330 may implement at least a portion of methods described herein, such as the methods illustrated by FIGS. 16-19. In other embodiments, different elements and data may be included. Note that the data storage 335 may include any data or information, as described herein.

Those skilled in the art will appreciate that the computing system 115 is merely illustrative and is not intended to limit the scope of embodiments. In particular, the computing system 115 and devices may include any combination of hardware or software that can perform the indicated functions, including computers, network devices, Internet appliances, PDAs, wireless phones, pagers, GPUs, specialized computer systems, information handling apparatuses, or the like. The computing system 115 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between a memory and other storage devices for purposes of memory management and data integrity. Alternatively, in other embodiments some or all of the software components may execute in a memory on another device and may communicate with the illustrated computing system 115 via inter-computer communication. Some or all of the system components or data structures may also be stored (e.g., as instructions or structured data) on a computer-accessible medium or a portable article to be read by an appropriate drive, various examples of which are described here. In some embodiments, instructions stored on a computer-accessible medium separate from the computing system 115 may be transmitted to the computing system 115 through transmission media or signals such as electrical, electromagnetic, or digital signals, conveyed via a communication medium such as a network and/or a wireless link. Various embodiments may further include receiving, sending, or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g., SDRAM, DDR, RDRAM, SRAM, or the like), ROM, or the like. In some embodiments, a computer-accessible medium may include transmission media or signals such as electrical, electromagnetic, or digital signals, conveyed via a communication medium such as network and/or a wireless link.

As described herein, the computing system 115, utilizing the at least one processor 305, is configured to execute one or more digital wayfinding operations. In certain embodiments, the computing system 115, utilizing one or more processors 305, generates an interface display for display on a display screen. The interface display may be used to set up a new user account or login into an existing user account to receive notifications as described herein.

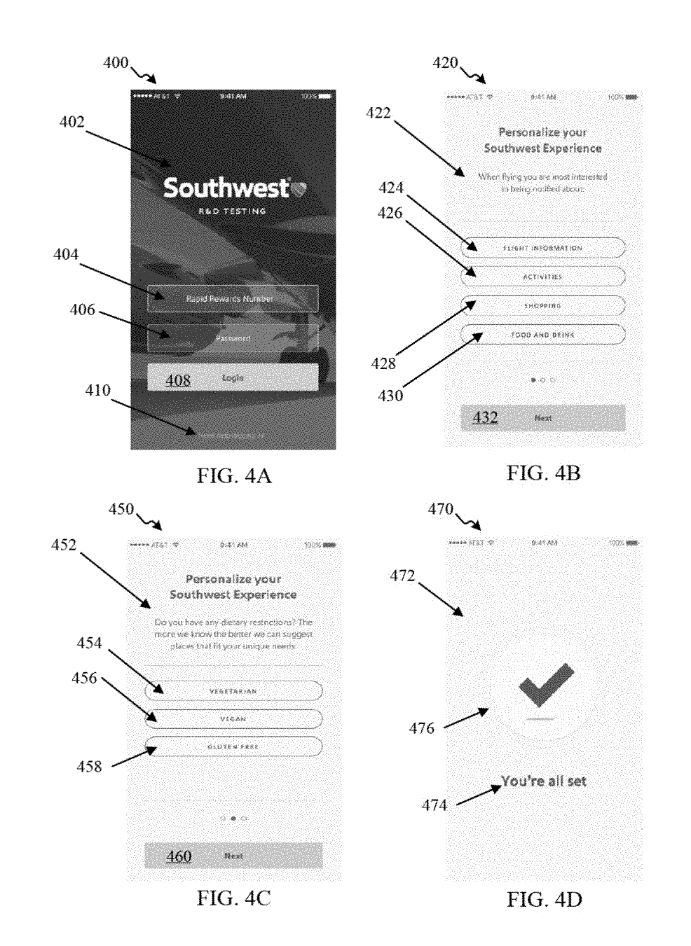

FIGS. 4A, 4B, 4C, and 4D illustrate non-limiting, example user interface displays 400, 420, 450, and 470, respectively, according to certain embodiments of this disclosure. As shown in FIG. 4A, the user interface display 400 may include a message 402. The message 402 may include a logo (e.g., a “SOUTHWEST AIRLINES™” logo) and a name associated with the user interface display 400. The user interface display 400 may also include a user identification (ID) field 404 (e.g., to receive a user's name, to receive a user's username, to receive a user's rapid rewards number), a password field 406, and a login selection button 408. The login selection button 408 may include a message (e.g., to “login”) providing an indication to a user viewing the user interface displays that the user may select the login selection button 408 after providing a user ID in the user ID field 404 and a password into the password field 406.

The user interface display 400 may also include login help selection link 410. The login help selection link 410 may direct a user viewing the user interface display 400 to recover a forgotten user ID or password or create a new password in order to log into a user account through the user interface display 400. The login help selection link 410 may direct a user viewing the user interface display 400 to authenticate themselves with a user ID recover system or a password recovery system. The login help selection link 410 may direct a user viewing the user interface display 400 to answer one or more questions with specific answers that are unique to the user to log into a user account through the user interface display 400.

In operation, the computing system 115, utilizing the at least one processor 305 executing one or more digital wayfinding operations may generate the user interface display 400 for display on a display screen. After generating the user interface display 400 for display on a display screen, the computing system 115 may receive a user ID in the user ID field 404 and a password in the password field 406 and subsequently receive a selection of the login selection button 408. The computing system 115 may determine that the user ID provided in the user ID field 404 and the password provided in the password field 406 are authenticated and subsequently generate the user interface display 420 illustrated in FIG. 4B for display on a display screen.

As shown in FIG. 4B, the user interface display 420 includes a message 422. The message 422 may include a name for the user interface display 420 and one or more instructions for the user interface display 420. For example, the message 422 may recite “Personalize your Southwest Experience” and “When flying you are most interested in being notified about.” The user interface display 420 may also include one or more selection buttons such as a first selection button 424, a second selection button 426, a third selection button 428, and a fourth selection button 430. As shown in FIG. 4B, the first selection button 424 may include the text “FLIGHT INFORMATION” and when selected may provide travel information of one or more trips to be taken by a user associated with the user account. The second selection button 426 may include the text “ACTIVITIES” and when selected may provide a list of one or more activities that the user associated with the user account may be interested in. The third selection button 428 may include the text “SHOPPING” and when selected may provide a list of one or more brick-and-motor merchant stores that the user associated with the user account may be interested in. The fourth selection button 430 may include the text “FOOD AND DRINK” and when selected may provide a list of food types and beverage types that the user associated with the user account may be interested in. The user interface 420 may also include a next display screen selection button 432 that when selected causes the computing system 115 to generate another display screen for display on a display screen.

In operation, the computing system 115, utilizing the at least one processor 305 executing one or more digital wayfinding operations may generate the user interface display 420 for display on a display screen. After generating the user interface display 420 for display on a display screen, the computing system 115 may receive a selection of at least one of the first selection button 424, the second selection button 426, the third selection button 428, or the fourth selection button 430. Subsequently, the computing system 115 may receive a selection of the next display screen selection button 432 and generate the user interface display 450 illustrated in FIG. 4C for display on a display screen.

As shown in FIG. 4C, the user interface display 450 includes a message 452. The message 452 may include a name for the user interface display 450 and one or more instructions for the user interface display 450. For example, the message 452 may recite “Personalize your Southwest Experience” and “Do you have any dietary restrictions? The more we know the better we can suggest places that fit your unique needs.” The user interface display 450 may also include one or more selection buttons such as a first selection button 454, a second selection button 456, and a third selection button 458. As shown in FIG. 4C, the first selection button 454 may include the text “VEGETARIAN” and when selected may provide an indication that a user associated with the user account is a vegetarian. The second selection button 456 may include the text “VEGAN” and when selected may provide an indication that the user associated with the user account is a vegan. The third selection button 458 may include the text “GLUTEN FREE” and when selected may provide an indication that the user associated with the user account may prefer gluten free food. The user interface 450 may also include a next display screen selection button 460 that when selected causes the computing system 115 to generate another display screen.

In operation, the computing system 115, utilizing the at least one processor 305 executing one or more digital wayfinding operations may generate the user interface display 450 for display on a display screen. After generating the user interface display 450 for display on a display screen, the computing system 115 may receive a selection of at least one of the first selection button 454, the second selection button 456, and the third selection button 458. Subsequently, the computing system 115 may receive a selection of the next display screen selection button 460 and generate the user interface display 470 illustrated in FIG. 4D for display on a display screen.

As shown in FIG. 4D, the user interface display 470 includes a message 472. The message 472 may include an indication 474 that a personalization procedure is complete and selection button 476. For example, the indication 474 may recite “You're all set.” The selection button 476 when selected causes the computing system 115 to generate another display screen.

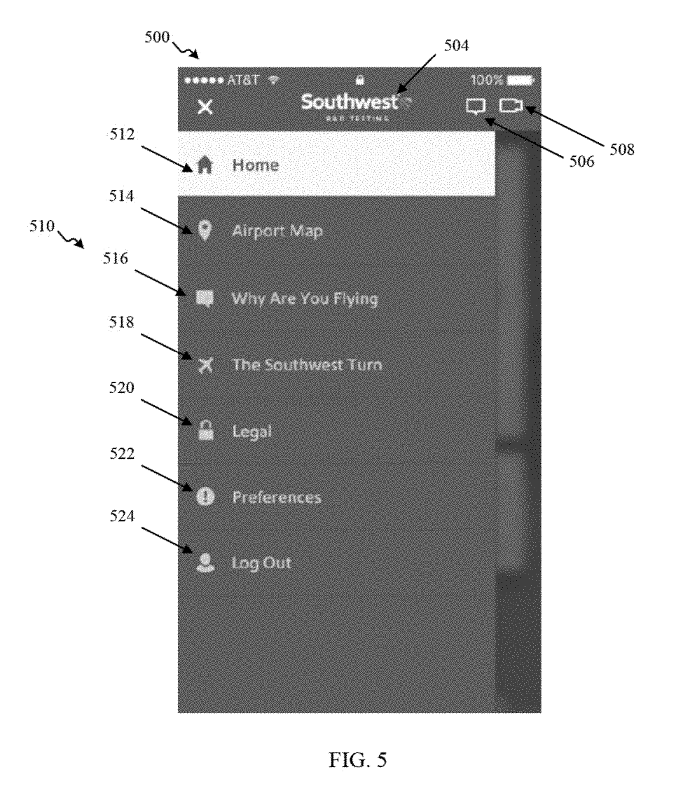

In operation, the computing system 115, utilizing the at least one processor 305 executing one or more digital wayfinding operations may generate the user interface display 470 for display on a display screen. After generating the user interface display 470 for display on a display screen, the computing system 115 may receive a selection of the selection button 476 and generate a user interface menu display 500 illustrated in FIG. 5 for display on a display screen.

FIG. 5 illustrates a non-limiting, example user interface menu display 500 according to certain embodiments of this disclosure. As shown in FIG. 5, the user interface menu display 500 may include a title message 504, a customer service chat selection icon 506, a pictorial display icon 508, and a plurality of menu selection options 510. The title message 504 may include at least one of a logo, a title of the page, a name of a brand associated with the user interface menu display 500, or a subtitle of the page. For example, the title message 504 may recite “SOUTHWEST™” in a logo form. The customer service chat selection icon 506 when selected may cause the computing system 115 to generate a user interface customer service chat display described herein. The pictorial display icon 508 when selected may cause the computing system 115 to generate the user interface pictorial display described herein.

The plurality of menu selection options 510 may include a home screen display selection button 512, an airport map display selection button 514, a social media communication display selection button 516 (e.g., displaying text reciting “Why Are You Flying”), a transportation notification selection button 518 (e.g., displaying text reciting “The Southwest Turn”), a legal information display selection button 520, a user preferences display and update selection button 522, and a log out selection button 524.

In operation, when the computing system 115 receives a selection of the legal information display selection button 520, the computing system 115 may generate one or more legal documents for display on a display screen. When the computing system 115 receives a selection of the user preference display an update selection button 522, the computing system 115 may generate one or more displays to display current preferences associated with a user of the user account and to receive updated preferences associated with a user of the user account. When the computing system 115 receives a selection of the log out selection button 524, the computing system 115 may initiate logout operations associated with the user account.

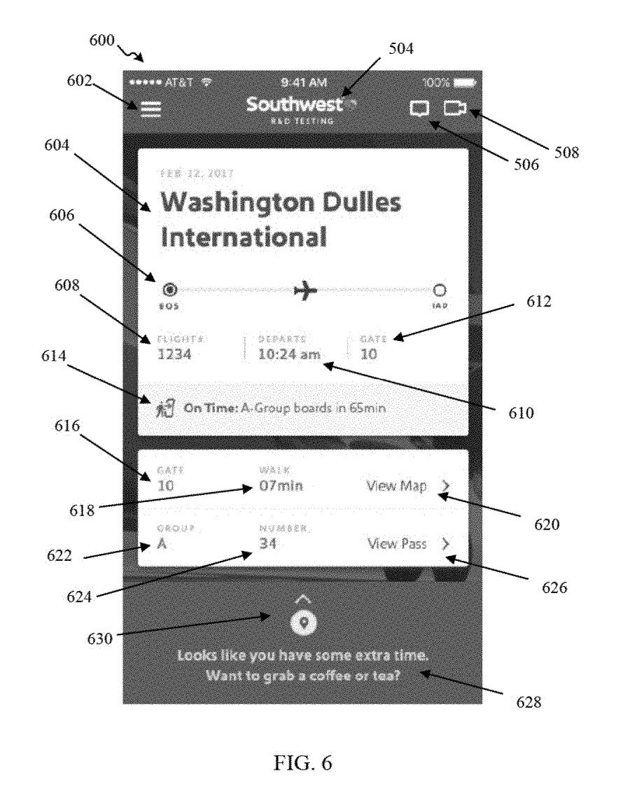

In operation, the computing system 115, utilizing the at least one processor 305 executing one or more digital wayfinding operations may generate the user interface menu display 500 for display on a display screen. After generating the user interface menu display 500 for display on a display screen, the computing system 115 may receive a selection of at least one of the plurality of menu selection buttons 510. For example, the computing system 115 may receive a selection of the home screen display selection button 512 and generate the user interface home display 600 illustrated in FIG. 6 for display on a display screen.

FIG. 6 illustrates a non-limiting, example user interface home display 600 according to certain embodiments of this disclosure. As shown in FIG. 6, the user interface home display 600 includes a user interface menu display selection button 602. The computing system 115 may receive a selection of the user interface menu displays selection button 602 and cause the computing system 115 to generate the user interface menu display 500 illustrated in FIG. 5. The user interface home display 600 also includes a transportation facility identification message field 604, a transport vehicle origin and destination indication field 606, a transportation identification number field 608, a transportation information departure time field 610, a transportation information departure gate field 612, a boarding status field 614, another transportation information departure gate field 616, a walking duration to the departure gate field 618, a transportation facility map selection icon 620, a boarding group indication field 622, a boarding number indication field 624, a boarding pass viewing display selection icon 626, a suggestion message display 628, and an activities selection link icon 630.

In operation, the computing system 115, utilizing the at least one processor 305 executing one or more digital wayfinding operations, may generate the user interface home display 600 for display on a display screen. The computing system 115, utilizing the at least one processor 305 executing one or more digital wayfinding operations, may populate at least one of the transportation facility identification message field 604, the transport vehicle arrival indication field 606, the transportation identification number field 608, the transportation information departure time field 610, the transportation information departure gate field 612, the boarding status field 614, the other transportation information departure gate field 616, the walking duration to the departure gate field 618, the transportation facility map selection icon 620, the boarding group indication field 622, the boarding number indication field 624, the boarding pass viewing display selection icon 626, the suggestion message display 628, or the activities selection link icon 630.

The computing system 115 of the electronic device 110, utilizing the at least one processor 305 executing one or more digital wayfinding operations, receives travel information of the user account associated with the electronic device 110. For example, the computing system 115 may receive a selection of the home screen display selection button 512 on the user interface menu display 500 illustrated in FIG. 5. After receiving the selection of the home screen display selection button 512, the computing system 115 may transmit a request to the one or more servers 120 for travel information of the user account associated with the electronic device 110. The computing system 115 of the electronic device 110 may receive the travel information from the one or more servers 120 after transmitting the request. In certain embodiments, the computing system 115 may receive travel information from the one or more servers 120 that includes one or more scheduled travel times. For example, one or more scheduled travel times may include at least one of a transportation check-in time, a transportation boarding time, a transportation departure time, a transportation arrival time, a transportation baggage pick-up time, or the like. In certain embodiments, the travel information may additionally include at least one of a user name, a user status, a user travel code, a user travel preference, a transportation identification, a departure location, an arrival location, a transportation boarding classification, a baggage pick-up location, or the like.

The computing system 115 of the electronic device 110, utilizing the at least one processor 305 executing one or more digital wayfinding operations, determines a location of the electronic device 110. In certain embodiments, the computing system 115 of the electronic device 110 determines a location of the electronic device 110 relative to one or more nodes (e.g., nodes 1-8 illustrated in FIG. 2) within a transportation facility (e.g., a transportation hub 220 illustrated in FIG. 2). A transportation facility may include a plurality of nodes dispersed throughout the transportation facility. Nodes may be placed at one or more transportation facility gates, within one or more transportation facility terminals, at one or more transportation facility security checkpoints, at one or more transportation facility baggage claims, at one or more transportation facility parking garage is the parking lots, at one or more transportation facility ticket check-in and baggage drop off counters, at one or more transportation facility merchant locations, or the like. Each of the one or more nodes may transmit a beacon signal that extends to a range from each node. The computing system 115 may receive beacon signals from one or more nodes and determine that the electronic device 110 is closest to a particular node among the one or more nodes based on a particular beacon signal having a signal strength that is greater than a signal strength of the other received beacon signals. The computing system 115 may determine that the location of the electronic device 110 is at or nearest to the particular node that transmitted the beacon signal with the greatest signal strength. The computer system 115 may determine the location of electronic device 110 based on knowing or identifying the location of the particular node that transmitted the beacon signal with the greatest signal strength. In certain embodiments, the computing system 115 may determine that the electronic device 110 is not within a transportation facility or within a predetermined distance of a transportation facility when the computing system 115 does not receive a beacon signal from one or more of the nodes.

Additionally, or alternatively, the computing system 115 may receive beacon signals from one or more nodes and determine that the electronic device 110 is within a predetermined distance from a particular node among the one or more nodes based on the particular beacon signal having a signal strength that is greater than a signal strength threshold. The computing system 115 may determine that the location of the electronic device 110 is within a predetermined distance of the particular node that transmitted the beacon signal with the signal strength that is greater than the signal strength threshold. The computer system 115 may determine the location of electronic device 110 based on knowing or identifying the location of the particular node that transmitted the beacon signal with the signal strength that is greater than the signal strength threshold. In certain embodiments, the computing system 115 may determine that the electronic device 110 is not within a transportation facility or within a predetermined distance of a transportation facility when the computing system 115 does not receive a beacon signal that has a signal strength that is above the signal strength threshold.

In certain embodiments, the computing system 115 of the electronic device 110 determines the location of the electronic device 110 using one or more global positioning systems (GPSs) or one or more wireless communication systems. For example, the computing system 115 to the electronic device 110 may use one or more GPSs or one or more wireless communication systems to determine that the electronic device 110 is located on a jetway or has been transported from a jetway into a transportation facility terminal. As another example, the computing system 115 of the electronic device 110 may use one or more GPSs or one or more wireless communication systems to determine that the electronic device 110 is located at a transportation facility gate or has been transported from the entrance to a transportation facility terminal to a transportation facility gate. As another example, the computing system 115 of the electronic device 110 may use one or more GPSs or one or more wireless communication systems to determine that the electronic device 110 is located at a particular position within a transport facility. As yet another example, the computing system 115 of the electronic device 110 may use one or more GPSs or one or more wireless communication systems to determine that the electronic device 110 is located at a security checkpoint. As yet another example, the computing system 115 of the electronic device 110 may use one or more GPS or one or more wireless communication systems to determine that the electronic device 110 is located near but outside a secured area of a transportation facility. As yet another example, the computing system 115 of the electronic device 110 may use one or more GPS or one or more wireless communication systems to determine that the electronic device 110 is located a distance away from a transportation facility (e.g., at a home or office of a user associated with a user account, on a road heading to a transportation facility).

The computing system 115 of the electronic device 110, utilizing the at least one processor 305 executing one or more digital wayfinding operations, determines a duration of time between a current time and the one or more scheduled travel times. In certain embodiments, the computing system 115 may determine a duration of time from the current time to the one or more scheduled travel times. The computing system 115 may include a clock that provides a current date and time. The computing system 115 may receive at least one of a transportation check-in time, a transportation boarding time, a transportation departure time, a transportation arrival time, or a transportation baggage pick-up time and determine the amount of time from the current time to at least one of the transportation check-in time, the transportation boarding time, the transportation departure time, a transportation arrival time, a transportation baggage pick-up time and compare at least one of those times with the current time to determine the duration of time between the current time and one or more schedule travel times.

For example, the computing system 115 may determine an amount of time from a current time to an initial boarding time of a transport vehicle. As another example, the computing system 115 may determine an amount of time from a current time to a final boarding time of a transport vehicle. As yet another example, the computing system 115 may determine an amount of time from a current time to a time when a transport vehicle pushes away from a transportation facility gate. As yet another example, the computing system 115 may determine an amount of time from a current time to a time when a transport vehicle arrives at a transportation facility gate. As yet another example, the computing system 115 may determine an amount of time from a current time to a time when baggage will be available for retrieval at a transportation facility baggage claim area. As yet another example, the computing system 115 may determine an amount of time from a current time to a time when a passenger may be first able to check-in for a transportation activity.

The computing system 115 of the electronic device 110, utilizing the at least one processor 305 executing one or more digital wayfinding operations, generates, for display on a display screen associated with the electronic device, one or more travel notifications based on the location of the electronic device, the duration of time, and the travel information. For example, the computing system 115 may determine that the electronic device 110 is located at a first gate of a transportation facility (e.g., having deplaned from an airplane located at the first gate). The computing system 115 may also determine, using received travel information, that the user of the user account associated with the electronic device 110 is to board an airplane through a second gate at the transportation facility 150 minutes from the current time. The computing system 115 may generate, for display on a display screen associated with the electronic device 110, a travel notification suggesting one or more merchant stores within the transportation facility that the user of the user account associated with the electronic device 110 has time to visit while still having time to board the airplane at the second gate before the airplane departs from the second gate. In certain embodiments, the one or more suggested merchant stores may be located along the route between the first gate of the transportation facility and the second gate of the transportation facility. In certain embodiments, the travel notification suggesting the one or more merchant stores may also be based on one or more preferences provided by and associated with a user of the user account.

As another example, the computing system 115 may determine that the electronic device 110 is located at a security checkpoint within a transportation facility. The computer system 115 may determine, using received travel information, that an amount of time from a current time to a final boarding time onto the transport vehicle is less than the threshold time. The computing system 115 may generate, for display on a display screen associated with the electronic device 110, a travel notification indicating that the transport vehicle is located at a particular transportation facility gate and is currently receiving fuel and maintenance and a travel notification indicating that an initial group of passengers will begin boarding the transport vehicle and 20 minutes.

As yet another example, the computing system 115 may determine that the electronic device 110 is located several miles from the transportation facility. The computer system 115 may determine, using received travel information, that an amount of time from a current time to a final boarding time onto the transport vehicle is less than the threshold time. The computing system 115 may generate, for display on a display screen associated with the electronic device 110, a travel notification suggesting that the user of the user account associated with the electronic device 110 depart from the current location of electronic device 110 within the next 30 minutes to board the transport vehicle before the transport vehicle departs. In certain embodiments, the computing system 115 may additionally or alternatively generate, for display on a display screen associated with the electronic device 110, a travel notification suggesting one or more particular parking garages at the transportation facility based on a level of occupancy and a proximity to a terminal or a gate from which the transport vehicle will depart. In certain embodiments, the computing system 115 may additionally or alternatively generate, for display on a display screen associated with the electronic device, a travel notification suggesting one or more particular security checkpoints having a wait time that is below a threshold wait time.

As yet another example, the computing system 115 may determine that the electronic device 110 is located several miles from the transportation facility. The computer system 115 may determine, using received travel information, that an amount of time from a current time to a final boarding time onto the transport vehicle is greater than the threshold time. The computing system 115 may generate, for display on a display screen associated with the electronic device 110, a travel notification suggesting that if the user of the user account associated with the electronic device 110 departs from the current location of electronic device 110 within the next 30 minutes for the transportation facility, the user of the user account associated with the electronic device 110 may have time to visit one or more merchant stores within the transportation facility. In certain embodiments, the computing system 115 may additionally or alternatively generate, for display on a display screen associated with the electronic device 110, a travel notification suggesting one or more lower-cost parking garages at the transportation facility that are further away from a terminal or a gate from which the transport vehicle will depart then one or more other parking garages at the transportation facility.

As yet another example, the computing system 115 may determine that the electronic device 110 is located at a gate of a transportation facility (e.g., having deplaned from an airplane located at the gate). The computing system 115 may also determine, using received travel information, that the user of the user account associated with the electronic device 110 is to arrive at the gate of the transportation facility at a time that is new later than the current time. The computing system 115 may further determine, using received travel information, that the user of the user account associated with the electronic device 110 has checked bags onto the airplane. Thus, the computing system 115 may determine that the user of the user account associated with the electronic device 110 may want to retrieve the bags at a baggage claim of the transportation facility. The computing system 115 may generate, for display on a display screen associated with the electronic device 110, a travel notification indicating a location of the baggage claim where the bags may be retrieved and directions from the gate of the transportation facility to the baggage claim where the bags may be retrieved. In certain embodiments, the computing system 115 may generate, for display on a display screen associated with the electronic device 110, a travel notification suggesting one or more merchant stores within the transportation facility that the user of the user account associated with the electronic device 110 may wish to visit before reaching the baggage claim. In certain embodiments, the one or more suggested merchant stores may be located along the route between the gate of the transportation facility and the baggage claim. In certain embodiments, the travel notification suggestions of the one or more merchant stores may also be based on one or more preferences provided by and associated with a user of the user account.

In certain embodiments, a travel notification may include at least one of a transportation status, an indication of a duration of time between the current time and a change of the transportation status, a recommended departure time from the location of the electronic device to a transportation departure location, an indication of a transportation departure location, an indication of one or more merchant locations between the location of the electronic device and a transportation departure location, an indication of a travel time from the location of the electronic device to one or more merchant locations, an indication of one or more baggage pick-up locations, an indication of a travel time from the location of the electronic device to one or more baggage pick-up locations, an indication of one or more suggested automobile parking locations, an indication of one or more suggested baggage drop-off locations, an indication of one or more user check-in locations, a current security wait time at one or more security check-points, an offer to view through the display screen associated with the electronic device at least one of an image or a video of a transportation departure location, a request to receive user feedback, an offer to receive transportation status updates, an offer to communicate with a customer service representative, an offer to generate an image of a transportation boarding pass, or the like.

As discussed herein with respect to FIG. 6, in operation, the computing system 115, utilizing the at least one processor 305 executing one or more digital wayfinding operations, may generate the user interface home display 600 for display on a display screen. The computing system 115, utilizing the at least one processor 305 executing one or more digital wayfinding operations, may generate, for display on a display screen associated with the electronic device 110 (e.g., using the user interface home display 600) one or more travel notifications based on the location of the electronic device 110, the duration of time between a current time and one or more scheduled travel times, and the received travel information, and may populate at least one of the transportation facility identification message field 604, the transport vehicle arrival indication field 606, the transportation identification number field 608, the transportation information departure time field 610, the transportation information departure gate field 612, the boarding status field 614, the other transportation information departure gate field 616, the walking duration to the departure gate field 618, the transportation facility map selection icon 620, the boarding group indication field 622, the boarding number indication field 624, the boarding pass viewing display selection icon 626, the suggestion message display 628, or the activities selection link icon 630.

For example, as shown in FIG. 6, the transportation facility identification message field 604 may be populated with a date (e.g., Feb. 12, 2017) and a particular transportation facility (e.g., Washington Dulles International) to be utilized by a user of a user account associated with the electronic device 110. The transport vehicle origin and destination indication field 606 may be populated with a pictorial diagram illustrating how far a transport vehicle to be used by the user of the user account associated is from the transportation facility (e.g., a proportional distance from Boston Logan Airport to Washington Dulles International Airport). The transportation identification number field 608 may be populated with the flight number (e.g., 1234). The transportation information departure time field 610 may be populated with a departure time (e.g., 10:24 am). The transportation information departure gate field 612 may be populated with a departure gate (e.g., gate 10). The boarding status field 614 may populated with a boarding or flight indication (e.g., that Group A boards on time in 65 minutes). The other transportation information departure gate field 616 may be populated with the departure gate (e.g., gate 10). The walking duration to the departure gate field 618 (from a current location of the electronic device 110) may be populated with a time (e.g., 7 minutes). The transportation facility map selection icon 620 may be linked to map of Washington Dulles International and a route from the current location of the electronic device 110 to gate 10. The boarding group indication field 622 may be populated with a boarding group (e.g., Group A). The boarding number indication field 624 may be populated with a boarding number (e.g., 34). The boarding pass viewing display selection icon 626 may be linked to a boarding pass to be presented at a security checkpoint and at gate 10 during boarding. The suggestion message display 628 may be populated with a suggestion message (e.g., reciting “Looks like you have some extra time. Want to grab a coffee or tea?”). The activities selection link icon 630 may be linked to one or more merchant store locations within Washington Dulles International (e.g., one or more merchant stores that sell coffee or tea).

In certain embodiments, one or more of the fields may be populated or one or more of the selection icons may be linked by the computing system 115 based on the location of the electronic device 110 or the duration of time between the current time and the one or more received schedules travel times. For example, the computing system 115 may not populate the transport vehicle origin and destination indication field 606 when at least one of the duration of time between the current time and the one or more received schedules travel times is greater than a threshold time or the distance between the current location of the electronic device 110 and gate 10 at Washington Dulles International is greater than a threshold distance. Conversely, the computing system 115 may populate the transport vehicle origin and destination indication field 606 when at least one of the duration of time between the current time and the one or more received schedules travel times is no greater than a threshold time or the distance between the current location of the electronic device 110 and gate 10 at Washington Dulles International is no greater than a threshold distance.

As another example, the computing system 115 may not populate (or provide a link where applicable) at least one of the transportation facility identification message field 604, the boarding status field 614, the walking duration to the departure gate field 618, the transportation facility map selection icon 620, the boarding group indication field 622, the boarding number indication field 624, the boarding pass viewing display selection icon 626, the suggestion message display 628, or the activities selection link icon 630 when the duration of time between the current time and the one or more received schedules travel times is less than a threshold time and the distance between the current location of the electronic device 110 and gate 10 at Washington Dulles International is greater than a threshold distance. Alternatively, in the aforementioned example, at least one of the affirmation fields or selection icons may provide a message to contact customer service and provide one or more methods (e.g., a phone number) to contact customer service, for example, to schedule another flight. Conversely, the computing system 115 may populate (or provide a link where applicable) at least one of the transportation facility identification message field 604, the boarding status field 614, the walking duration to the departure gate field 618, the transportation facility map selection icon 620, the boarding group indication field 622, the boarding number indication field 624, the boarding pass viewing display selection icon 626, the suggestion message display 628, or the activities selection link icon 630 when the duration of time between the current time and the one or more received schedules travel times is not less than a threshold time and the distance between the current location of the electronic device 110 and gate 10 at Washington Dulles International is not greater than a threshold distance.

It should also be understood that the computing system 115 of the electronic device 110 may populate one or more of the fields or selection icons with different information based on at least one of the location of the electronic device, the duration of time, and the travel information. For example, the computing system 115 of the electronic device 110 may populate only the transportation facility identification message field 604, the transport vehicle arrival indication field 606, the transportation identification number field 608, and the boarding status field 614 when the received travel information indicates the transportation activity (e.g., a flight) has been canceled. For instance, the transportation facility identification message field 604 may include a date, the name of the transportation facility, and an indication that the transportation activity has been canceled. The transport vehicle origin and destination indication field 606 may provide instructions to receive assistance (e.g., reciting “For assistance please see your nearest gate agent or call us at 1-800-123-4567”). The transportation identification number field 608 may provide the transportation identification number of the canceled transportation activity. The boarding status field 614 may provide an indication that the transportation activity has been canceled (e.g., reciting “Flight Canceled”).

As another example, the computing system 115 of the electronic device 110 may populate the boarding status field 614 with a message (e.g., a message reciting “Boarding Now: A-Group”) based on at least received travel information. As yet another example, the computing system 115 of the electronic device 110 may populate none of the fields and none of the selection icons with information (e.g., travel notifications) based on at least one of the location of the electronic device, the duration of time, and the travel information. For instance, the computing system 115 may populate none of the fields and none of the selection icons with travel notifications when the duration of time between the current time in the one or more scheduled to travel times from the received travel information is greater than the threshold and the location of the electronic device 110 is within a distance from the transportation facility.

In certain embodiments, the computing system 115 of the electronic device 110, utilizing the at least one processor 305 executing one or more digital wayfinding operations, may receive subsequent travel information of the user account associated with the electronic device 110. The subsequent travel information may include one or more second or subsequent scheduled travel times. The one or more second or subsequent scheduled travel times may also include at least one of a transportation check-in time, a transportation boarding time, a transportation departure time, a transportation arrival time, a transportation baggage pick-up time, or the like. In certain embodiments, the subsequent travel information may further include at least one of a user name, a user status, a user travel code, a user travel preference, a transportation identification, a departure location, an arrival location, a transportation boarding classification, a baggage pick-up location, or the like. The computing system 115 may receive the subsequent travel information using one or more same or similar systems and methods described herein with respect to the travel information and from one or more same or similar sources (e.g., through a user input interface, from the one or more servers 102) described herein with respect to the travel information. In certain embodiments, the subsequent travel information may include at least one of a user name, a user status, a user travel code, a user travel preference, a transportation identification, a departure location, an arrival location, a transportation boarding classification, or a baggage pick-up location.

In certain embodiments, the one or more second or subsequent scheduled travel times include at least one different scheduled travel time from the one or more scheduled travel times. For example, the computing system 115 may use the at least one different scheduled travel time to generate for display a new travel notification. The new travel notification may be populated in the boarding status field 614 of the user interface home display 600 illustrated in FIG. 6 and may recite, for example, “Boarding Now: A-Group.” In certain embodiments, the subsequent travel information may include at least one change of travel information from immediately preceding received travel information.

In certain embodiments, the computing system 115 of the electronic device 110, utilizing the at least one processor 305 executing one or more digital wayfinding operations, may determine an updated location of the electronic device 110. For example, after the computing system 115 receives the subsequent travel information of the user account associated with the electronic device 110, the computing system 115 may determine an updated location of the electronic device 110. The computing system 115 may determine the updated location of the electronic device 110 using one or more same or similar electronic device location determination methods and systems described herein.

In certain embodiments, the computing system 115 of the electronic device 110, utilizing the at least one processor 305 executing one or more digital wayfinding operations, may determine an updated duration of time between a current time and the one or more second scheduled travel times. For example, after the computing system 115 receives the subsequent travel information of the user account associated with the electronic device 110, the computing system 115 may determine an updated duration of time between a current time and the one or more subsequent or second scheduled travel times. The computing system 115 may determine the updated duration of time using one or more same or similar duration of time determination methods or systems described herein.

In certain embodiments, the computing system 115 of the electronic device 110, utilizing the at least one processor 305 executing one or more digital wayfinding operations, may generate, for display on the display screen associated with the electronic device, one or more new travel notifications based on the updated location of the electronic device, the updated duration of time, and the subsequent travel information. For example, after the computing system 115 receives the subsequent travel information of the user account associated with the electronic device 110, determines the update location of the electronic device 110, and determines an updated duration of time, the computing system 115 may determine generate, for display on a display screen associated with the electronic device 110, one or more new travel notifications. The one or more new travel notifications may include at least one of a transportation status, an indication of a duration of time between the current time and a change of the transportation status, a recommended departure time from the location of the electronic device to a transportation departure location, an indication of a transportation departure location, an indication of one or more merchant locations between the location of the electronic device and a transportation departure location, an indication of a travel time from the location of the electronic device to one or more merchant locations, an indication of one or more baggage pick-up locations, an indication of a travel time from the location of the electronic device to one or more baggage pick-up locations, an indication of one or more suggested automobile parking locations, an indication of one or more suggested baggage drop-off locations, an indication of one or more user check-in locations, a current security wait time at one or more security check-points, an offer to view through the display screen associated with the electronic device at least one of an image or a video of a transportation departure location, a request to receive user feedback, an offer to receive transportation status updates, an offer to communicate with a customer service representative, an offer to generate an image of a transportation boarding pass, or the like. The computing system 115 may generate, for display on a display screen of the electronic device 110, the one or more new travel notification using one or more same or similar methods or systems to generate the travel notifications described herein. In certain embodiments, new travel notifications may include at least one changed travel notification from immediately preceding generated travel notifications.

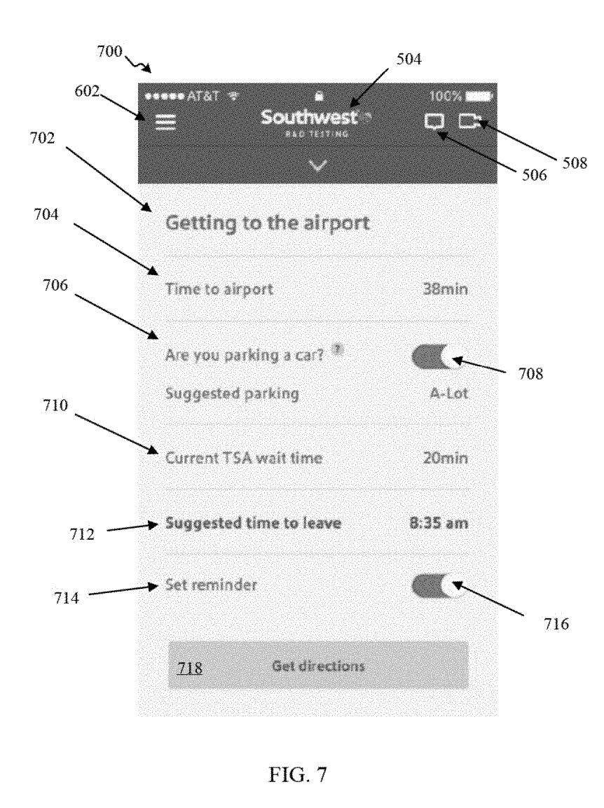

FIG. 7 illustrates a non-limiting, example user interface notification display 700 according to certain embodiments of this disclosure. The user interface notification display 700 illustrated in FIG. 7 may include information (e.g., travel notifications) that may generated for display to provide assistance and information for a user of a user account to schedule and navigate from a location away from a transportation facility to the transportation facility and to a transportation facility gate. As shown in FIG. 7, the user interface notification display 700 may include a title message field 702 (e.g., reciting “Getting to the airport”), an estimated time to airport field 704 displaying an estimated time (e.g., 38 minutes), a parking lot recommendation request field 706 including a toggle switch 708 that may be selected to indicate whether a parking lot recommendation is request. The parking lot recommendation request field 706 may display “A-lot” as a parking lot recommendation. A current security checkpoint wait time field 710 indicating a wait time of “20 min”. In certain embodiments, the current security checkpoint wait time field 710 may provide a wait time for each of a plurality of security checkpoints at a transportation facility. The current security checkpoint wait time field 710 may provide locations for each of the plurality of security checkpoints so that a user of a user account may choose and locate a security checkpoint with the shortest wait time. The suggested time to leave field 712 may provide an indication of a suggested time to leave for a transportation facility from a current location of the electronic device 110. The set reminder field 714 may include a toggle switch 716 to provide a reminder when a user of a user account must leave for the transportation facility from a current location of the electronic device 110. The get directions selection button 718 when selected may cause the computing system 115 to generate a map and directions for display of a route from the current locations of the electronic device 110 to the transportation facility or a gate at the transportation facility.

In operation, the computing system 115, utilizing the at least one processor 305 executing one or more digital wayfinding operations may generate the user interface notification display 700 for display on a display screen after the computing system 115 generates one or more travel notifications or one or more new travel notification as described herein. In certain embodiments, the computing system 115 may populate one or more fields of the user interface notification display 700 when the computing system 115 determines that the electronic device 110 is located at a distance that is greater than a predetermined distance from a transportation facility and when the determined duration of time is greater than a first threshold duration of time and less than a second threshold duration of time.

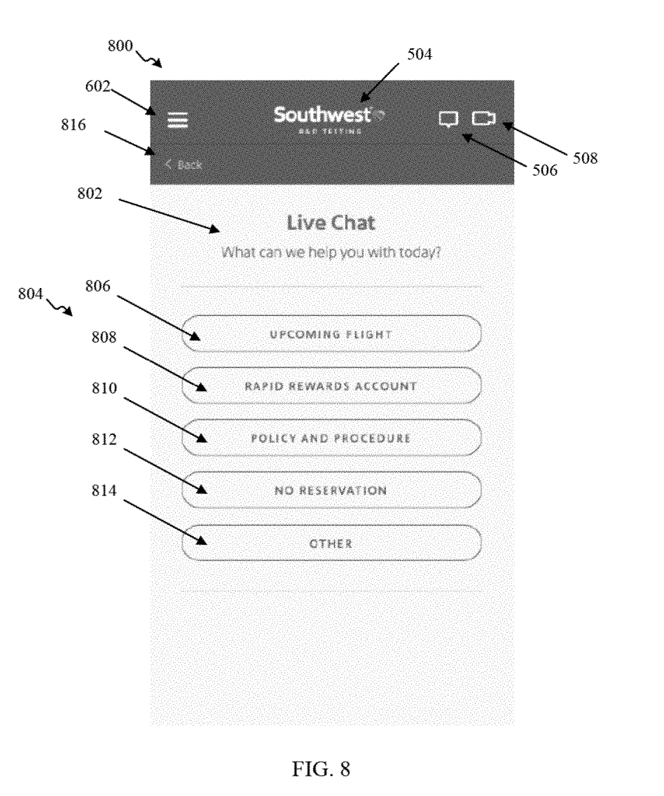

FIG. 8 illustrates a non-limiting, example user interface customer service communication display 800 according to certain embodiments of this disclosure. The computing system 115 may generate the user interface customer service communication display 800 for display in response to receiving a selection of the customer service chat selection icon 506. The user interface customer service communication display 800 may provide an interface of a user of a user account associated with the electronic device 110 to communicate with a customer service representative to discuss an upcoming flight, a user account, policies and procedures, a no reservation scenario, or discuss any other matters of concern. For example, as shown in FIG. 8, the user interface customer service communication display 800 may include a title message field 802 (e.g., reciting “Live Chat” and “What can we help you with today?”). The user interface customer service communication display 800 also includes a plurality of selection fields 804 including an upcoming flight selection field 806 that when selected informs a customer service representative that a communication will involve questions about an upcoming flight. The plurality of selection fields 804 also includes a user account selection field 808 that when selected informs a customer service representative that a communication will involve questions about a user account. The plurality of selection fields 804 also includes a policy and procedures selection field 810 that when selected informs a customer service representative that a communication will involve questions about policies and procedures. The plurality of selection fields 804 also includes a no reservation scenario selection field 812 that when selected informs a customer service representative that a communication will involve questions about a reservation that may have been lost or erroneously not booked. The plurality of selection fields 804 also includes another issue selection field 814 that when selected informs a customer service representative that a communication will involve questions not identified in the user interface customer service communication display 800. In certain embodiments, a received selection of the back selection icon 816 may cause the computing system 115 to generate at least one of the user interface menu display 500 illustrated in FIG. 5, the user interface home display 600 illustrated in FIG. 6, or the user interface notification display 700 illustrated in FIG. 7.

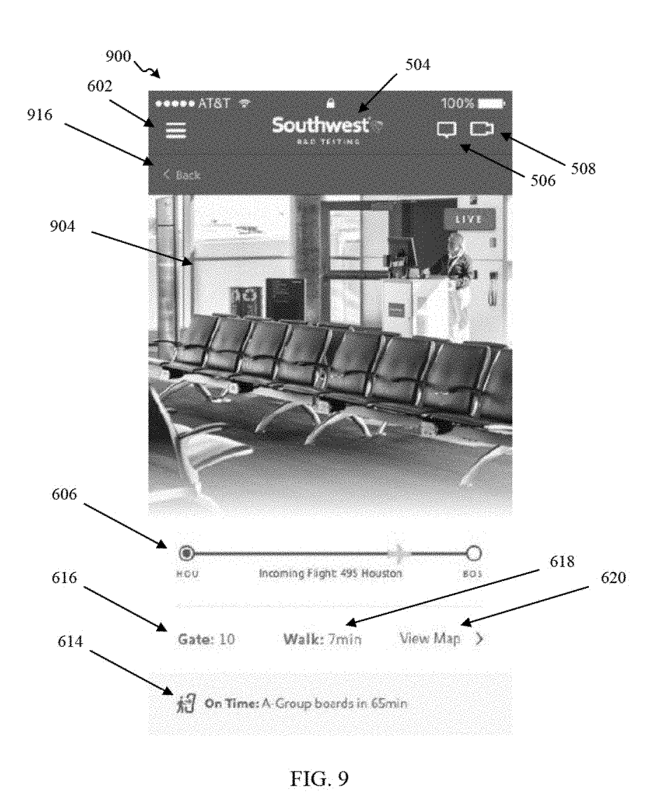

FIG. 9 illustrates a non-limiting, example user interface pictorial display 900 according to certain embodiments of this disclosure. The computing system 115 may generate the user interface pictorial display 900 for display in response to receiving a selection of the pictorial display icon 508. The user interface pictorial display 900 may provide a pictorial display of a section or area within a transportation facility for viewing. For example, the user interface pictorial display 900 may provide a graphic image display of a quantity of people located at or near a gate of a transportation facility for viewing, a graphic image display of a quantity of people lined up for boarding at gate of a transportation facility for viewing, an image (e.g., a blurred image) displayed of a quantity of people located at or near a gate of a transportation facility for viewing, an image (e.g., a blurred image) displayed of a quantity of people lined up for boarding at gate of a transportation facility for viewing, a video (e.g., a blurred video, a live video, a blurred live video) displayed of a quantity of people located at or near a gate of a transportation facility for viewing, a video (e.g., a blurred video, a live video, a blurred live video) displayed of a quantity of people lined up for boarding at gate of a transportation facility for viewing.

As shown in FIG. 9, the user interface pictorial display 900 includes a display section 904 that may display a graphic image, the transport vehicle origin and destination indication field 606 described herein, the boarding status field 614 described herein, the other transportation information departure gate field 616 described herein, a walking duration to the departure gate field 618 described herein, and a transportation facility map selection icon 620 described herein. In certain embodiments, a received selection of the back selection icon 916 may cause the computing system 115 to generate at least one of the user interface menu display 500 illustrated in FIG. 5, the user interface home display 600 illustrated in FIG. 6, or the user interface notification display 700 illustrated in FIG. 7.

In operation, the computing system 115, utilizing the at least one processor 305 executing one or more digital wayfinding operations may generate the user interface pictorial display 900 for display on a display screen after the computing system 115 generates one or more travel notifications or one or more new travel notification as described herein. In certain embodiments, the computing system 115 may populate one or more fields of the user interface pictorial display 900 when the computing system 115 determines that the electronic device 110 is located at a distance that is no greater than a predetermined distance from a transportation facility (e.g., within the transportation facility) and when the determined duration of time is no greater than a first threshold duration of time and no less than a second threshold duration of time. The user interface pictorial display 900 may be used by used by a user of a user account associated with the electronic device 110 to visually determine a level of activity present at a gate while the user is located at one or more locations (e.g., at a merchant location) away from the gate.

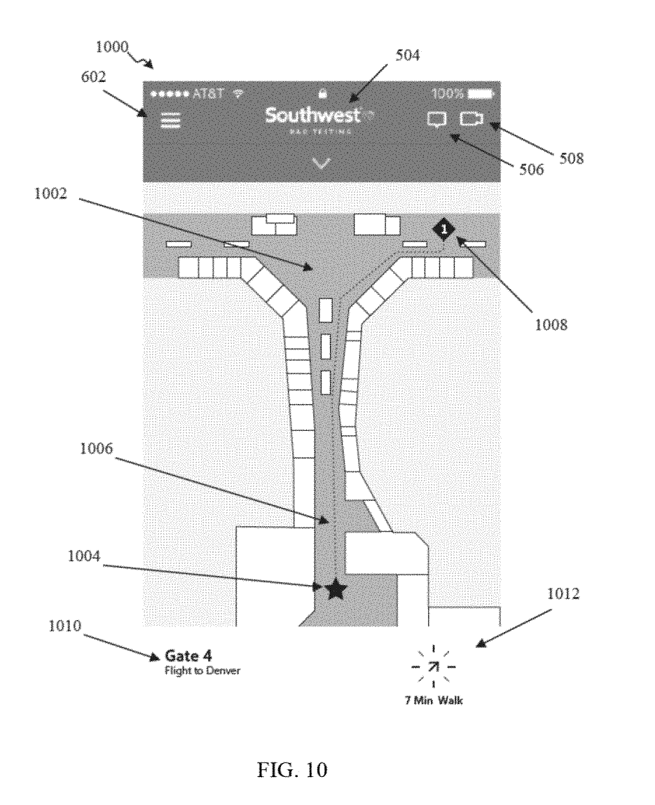

Turning back to FIG. 5, in response to receiving a selection of the airport map display selection button 514 displayed in the user interface menu display 500, the computing system 115 may generate an airport map for display. FIGS. 10, 11, 12, and 13 illustrate a non-limiting, example user interface map display 1000 according to certain embodiments of this disclosure. The user interface map display 1000 may provide a visual indication of a current location of the electronic device 110 relative to one or more gates within a transportation facility or one or more merchant stores within a transportation facility. As shown in FIG. 10, the user interface map display 1000 includes a map 1002 of at least a portion of a transportation facility. The map 1002 includes a location 1004 of the electronic device 110 and a path or route 1006 providing a direction from the location 1004 of the electronic device 110 to a gate 1008. The user interface map display 1000 may also include gate identification field 1010 and navigational field 1012. The gate identification field 1010 may provide an indication of the gate 1008 (e.g., “Gate 4) and a destination of a transport vehicle located (or to be located) at the gate 1008 (e.g., “Flight to Denver”). The navigational field 1012 may provide a general direction of the gate 1008 relative to the location of the electronic device (e.g., via a compass or an arrow) and walk time from the location of the electronic device 110 to the gate 1008.

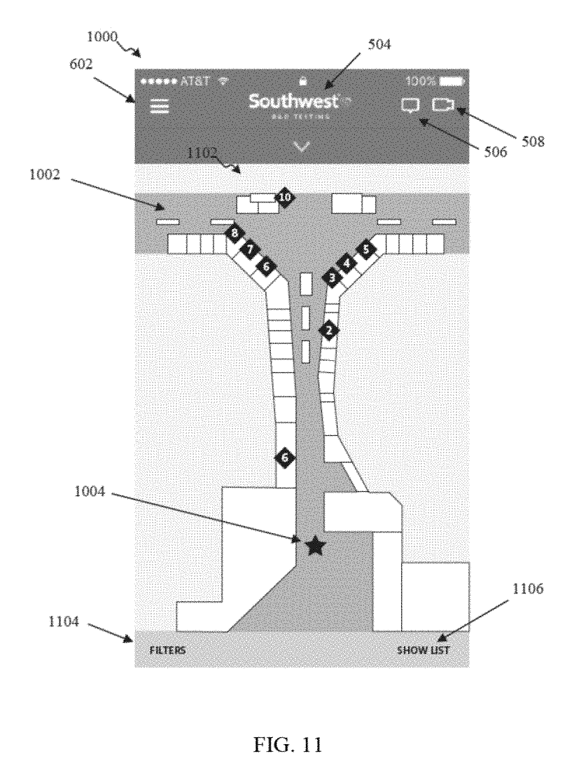

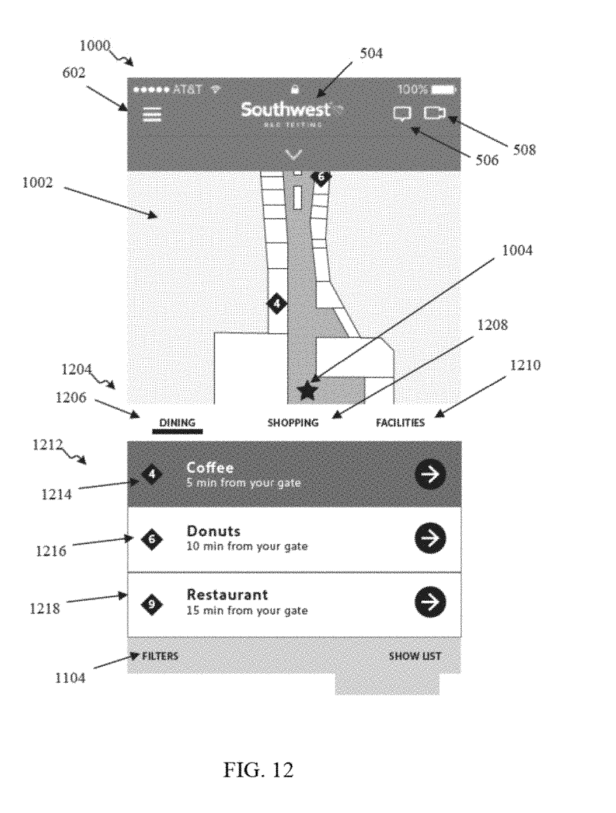

As shown in FIG. 11, the user interface map display 1000 includes a map 1002 of at least a portion of a transportation facility, a location 1004 of the electronic device 110 and plurality of merchant store locations 1102 (e.g., locations 2, 3, 4, 5, 6, 7, 8, and 10). The user interface map display 1000 may also include a filter selection icon 1104 and a show list selection icon 1106. In response to receiving a selection of the show list selection icon 1106, the computing system 115 may generate a list of the plurality of merchant stores having locations displayed in the map 1002. As shown in FIG. 12, the user interface map display 1000 a list 1204 of the plurality of merchant stores locations 1102 located by the map 1002. The list 1204 includes a plurality of merchant selection categories including a dining selection icon 1206 to narrow the list 1204 to merchants stores where dining is available, a shopping selection icon 1208 to narrow the list 1204 to merchant stores where shopping is available, and a facilities selection icon 1210 to narrow the list 1204 to merchant stores that include or are related to facilities. The list 1204 may include a plurality of merchant selection buttons 1212 that when selected provide additional details concerning a merchant. For example, the plurality of merchant selection buttons 1212 includes a first selection button 1214, a second selection button 1216, and a third selection button 1218. Each of the plurality of merchant selection buttons 1212 may include a name of the merchant store, an indication where the merchant store is located, and a walking distance from the current location of the electronic device 110 to the location of the merchant store.

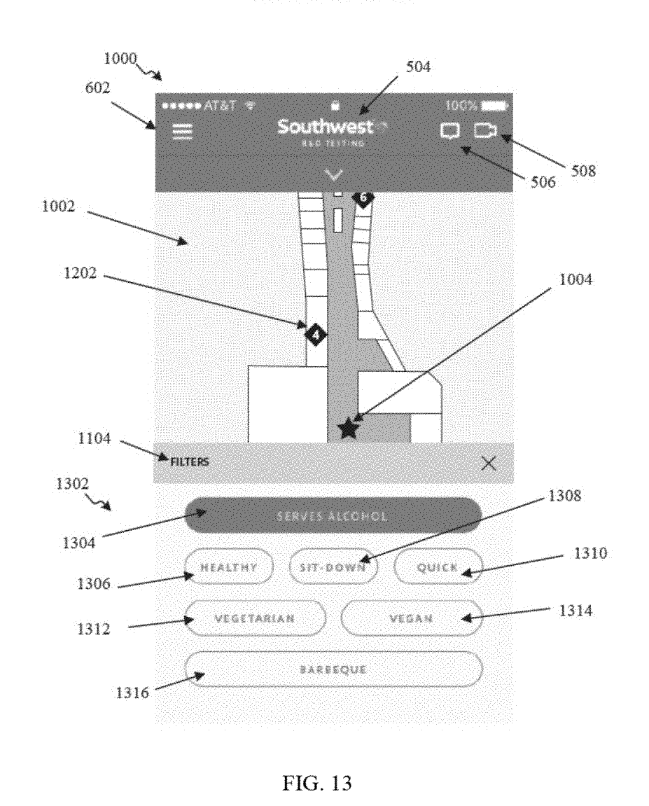

In response to receiving a selection of the filter selection icon 1104, the computing system 115 may generate a list of filter options to narrow or filter the list of the plurality of merchant store locations displayed in the map 1002. As shown in FIG. 13, the plurality of filters 1302 includes a serve alcohol filter selection button 1304 that when selected causes the computing system 115 to remove all merchant stores from the list 1204 that do not server alcohol. The plurality of filters 1302 includes a healthy filter selection button 1306 that when selected causes the computing system 115 to remove all merchant stores from the list 1204 that do not server healthy food. The plurality of filters 1302 includes a sit-down filter selection button 1308 that when selected causes the computing system 115 to remove all merchant stores from the list 1204 that do not allow people to sit-down at a table or bar. The plurality of filters 1302 includes a quick filter selection button 1310 that when selected causes the computing system 115 to remove all merchant stores from the list 1204 that do not provide pre-made food or fast food. The plurality of filters 1302 includes a vegetarian selection button 1312 and a vegan selection button 1314 that when selected causes the computing system 115 to remove all merchant stores from the list 1204 that do not provide vegetarian dishes and vegan dishes, respectively. The plurality of filters 1302 includes a barbeque filter selection button 1316 that when selected causes the computing system 115 to remove all merchant stores from the list 1204 that do not server barbeque.

In operation, the computing system 115, utilizing the at least one processor 305 executing one or more digital wayfinding operations may generate the user interface map display 1000 for display on a display screen after the computing system 115 generates one or more travel notifications or one or more new travel notification as described herein. In certain embodiments, the computing system 115 may populate the map 1002 and the list 1204 of the user interface map display 1000 when the computing system 115 determines that the electronic device 110 is located at a distance that is no greater than a predetermined distance from a transportation facility (e.g., within the transportation facility) and when the determined duration of time is no greater than a first threshold duration of time and no less than a second threshold duration of time. The user interface map display 1000 may be used by used by a user of a user account associated with the electronic device 110 to identify and locate one or more merchant stores within a transportation facility at or a near a gate or along a route between a location of the electronic device 110 and a gate.

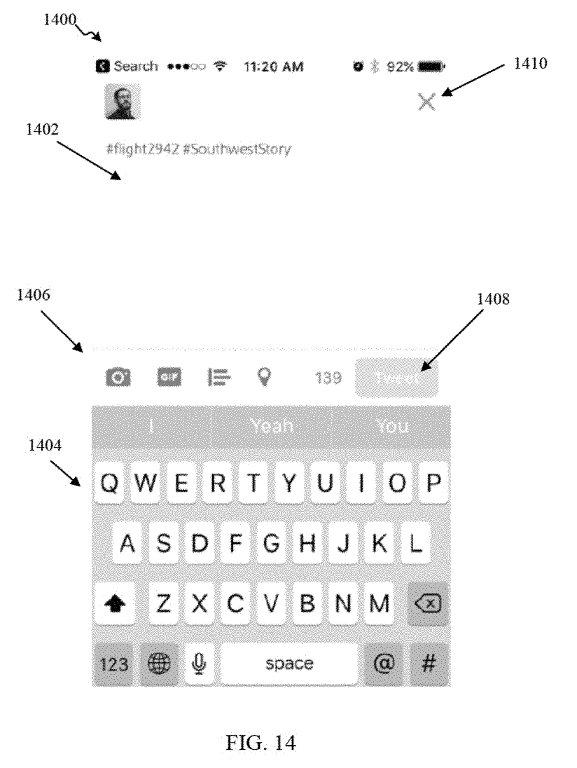

Turning back to FIG. 5, in response to receiving a selection of the social media communication display selection button 516 displayed in the user interface menu display 500, the computing system 115 may generate a user interface social media display. FIG. 14 illustrates a non-limiting, example user interface social media display 1400 according to certain embodiments of this disclosure. The user interface social media display 1400 allows a user of the user account associated with the electronic device 110 to use a social media platform to express a notion concerning a travel experience. The social media platform may include at least one of FACEBOOK™, INSTAGRAM™, TWITTER™, PINTREST™, or the like. As shown in FIG. 14, the user interface social media display 1400 may include a text display area 1402, a text input interface area 1404, and a plurality of text and multimedia options 1406 include a post text selection button 1408. The user interface social media display 1400 may be closed in response to receiving a selection of the “x” icon 1410.

In operation, the computing system 115, utilizing the at least one processor 305 executing one or more digital wayfinding operations may generate the user interface social media display 1400 for display on a display screen after the computing system 115 generates one or more travel notifications or one or more new travel notification as described herein. In certain embodiments, the computing system 115 may generate the user interface social media display 1400 when the computing system 115 determines that the electronic device 110 is located at a distance that is no greater than a predetermined distance from a transportation facility (e.g., within the transportation facility) and when the determined duration of time is no greater than a first threshold duration of time and no less than a second threshold duration of time.

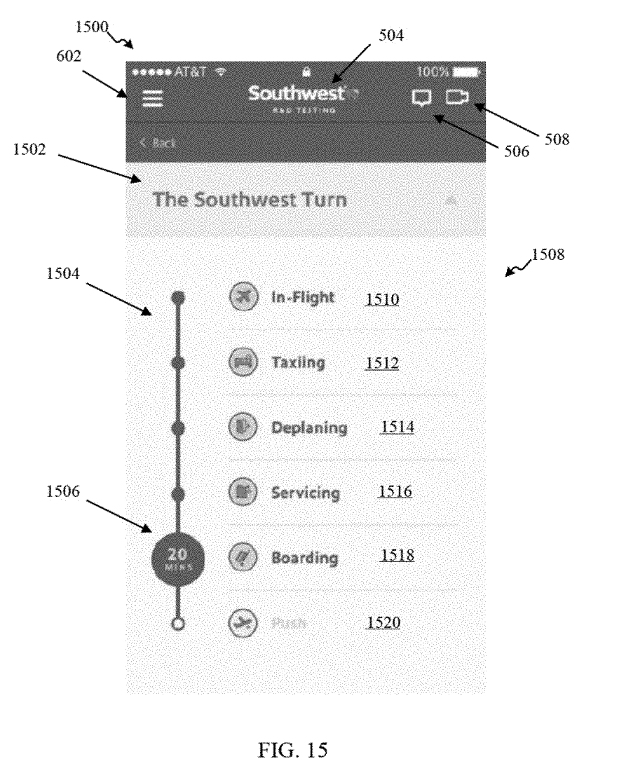

Turning back to FIG. 5, in response to receiving a selection of the transportation notification selection button 518 displayed in the user interface menu display 500, the computing system 115 may generate a user interface notification display. FIG. 15 illustrates another non-limiting, example user interface notification display 1500 according to certain embodiments of this disclosure. The user interface notification display 1500 allows a user of the user account associated with the electronic device 110 to identify a specific status of a transport vehicle or transportation activity related to a transport vehicle. As shown in FIG. 15, the user interface notification display 1500 may include a title message 1502 (e.g., reciting “The Southwest Turn”), a transport vehicle or transportation activity status bar 1504 includes a status marker 1506, and a plurality of status points 1508 that align with the status marker 1506 when a status of the transport vehicle or the transportation activity coincides with one of the plurality of status points 1508.

When the status marker 1506 aligns with one status point of the plurality of status points 1508, the status marker 1506 may provide an indication of a duration of time that the transport vehicle or transportation activity may have the respective status. The plurality status points 1508 may include an in-flight status point 1510, a taxiing status point 1512, a deplaning status point 1514, a servicing status point 1516, a boarding status point 1518, and a push status point 1520. When the status marker 1506 aligns with the in-flight status point 1510, the status marker 1506 may indicate that a transport vehicle to be arriving at a gate to be used by a user of a user account associated with the electronic device has not arrived at the gate and is currently in flight. When the status marker 1506 aligns with the taxiing status point 1512, the status marker 1506 may indicate that a transport vehicle to be arriving at a gate to be used by a user of a user account associated with the electronic device has not arrived at the gate but has landed and is currently taxiing to the gate. When the status marker 1506 aligns with the deplaning status point 1514, the status marker 1506 may indicate that a transport vehicle has arrived at a gate to be used by a user of a user account associated with the electronic device and passengers are currently exiting the transport vehicle and entering the transportation facility. When the status marker 1506 aligns with the servicing status point 1516, the status marker 1506 may indicate that a transport vehicle has arrived at a gate to be used by a user of a user account associated with the electronic device and is currently being refueled or serviced for a subsequent transportation activity. When the status marker 1506 aligns with the boarding status point 1518, the status marker 1506 may indicate that a transport vehicle has arrived at a gate to be used by a user of a user account associated with the electronic device and is currently being boarded by passengers. When the status marker 1506 aligns with the push status point 1520, the status marker 1506 may indicate that a transport vehicle previously boarded by passengers at a gate used (or to be used) by a user of a user account associated with the electronic device and has pushed away from the gate to initiate a new transportation activity.

It should be understand that as the status marker 1506 moves along the status bar 1504 and past a status point, the position of the status marker 1506 down or past the status point indicates that the transport vehicle was previously at the status point and has since change statuses indicative of a new status point that is aligned with the status marker 1506. In operation, the computing system 115, utilizing the at least one processor 305 executing one or more digital wayfinding operations may generate the user interface notification display 1500 for display on a display screen after the computing system 115 generates one or more travel notifications or one or more new travel notification as described herein. In certain embodiments, the computing system 115 may generate the user interface notification display 1500 when the computing system 115 determines that the electronic device 110 is located at a distance that is no greater than a predetermined distance from a transportation facility (e.g., within the transportation facility) and when the determined duration of time is no greater than a first threshold duration of time and no less than a second threshold duration of time.

FIG. 16 illustrates a non-limiting, example method 1600 for performing one or digital wayfinding operations according to certain embodiments of this disclosure. Although certain details will be provided with reference to the method 1600 of FIG. 16, it should be understood that other embodiments may include more, less, or different method steps. In certain embodiments, the method 1600 may be implemented by a computing system 115 of an electronic device 110. At step 1601, the computing system 115 is in an idle state at least with respect to performing one or more digital wayfinding operations.

At step 1603, the computing system 115 receives travel information of a user account associated with the electronic device. For example, the computing system 115 may receive a selection of the home screen display selection button 512 on the user interface menu display 500 illustrated in FIG. 5. After receiving the selection of the home screen display selection button 512, the computing system 115 may transmit a request to the one or more servers 120 for travel information of the user account associated with the electronic device 110. The computing system 115 of the electronic device 110 may receive the travel information from the one or more servers 120 after transmitting the request. In certain embodiments, the computing system 115 may receive travel information from the one or more servers 120 that includes one or more scheduled travel times. For example, one or more scheduled travel times may include at least one of a transportation check-in time, a transportation boarding time, a transportation departure time, a transportation arrival time, a transportation baggage pick-up time, or the like. In certain embodiments, the travel information further includes at least one of a user name, a user status, a user travel code, a user travel preference, a transportation identification, a departure location, an arrival location, a transportation boarding classification, a baggage pick-up location, or the like.

At step 1605, the computing system 115 determines a location of the electronic device. In certain embodiments, the computing system 115 of the electronic device 110 determines a location of the electronic device 110 relative to one or more nodes (e.g., nodes 1-8 illustrated in FIG. 2) within a transportation facility (e.g., a transportation hub 220 illustrated in FIG. 2). A transportation facility may include a plurality of nodes dispersed throughout the transportation facility. Nodes may be placed at one or more transportation facility gates, within one or more transportation facility terminals, at one or more transportation facility security checkpoints, at one or more transportation facility baggage claims, at one or more transportation facility parking garage is the parking lots, at one or more transportation facility ticket check-in and baggage drop off counters, at one or more transportation facility merchant locations, or the like. Each of the one or more nodes may transmit a beacon signal that extends to a range from each node. The computing system 115 may receive beacon signals from one or more nodes and determine that the electronic device 110 is closest to a particular node among the one or more nodes based on a particular beacon signal having a signal strength that is greater than a signal strength of the other received beacon signals. The computing system 115 may determine that the location of the electronic device 110 is at or nearest to the particular node that transmitted the beacon signal with the greatest signal strength. The computer system 115 may determine the location of electronic device 110 based on knowing or identifying the location of the particular node that transmitted the beacon signal with the greatest signal strength. In certain embodiments, the computing system 115 may determine that the electronic device 110 is not within a transportation facility or within a predetermined distance of a transportation facility when the computing system 115 does not receive a beacon signal from one or more of the nodes.

Additionally, or alternatively, the computing system 115 may receive beacon signals from one or more nodes and determine that the electronic device 110 is within a predetermined distance from a particular node among the one or more nodes based on the particular beacon signal having a signal strength that is greater than a signal strength threshold. The computing system 115 may determine that the location of the electronic device 110 is within a predetermined distance of the particular node that transmitted the beacon signal with the signal strength that is greater than the signal strength threshold. The computer system 115 may determine the location of electronic device 110 based on knowing or identifying the location of the particular node that transmitted the beacon signal with the signal strength that is greater than the signal strength threshold. In certain embodiments, the computing system 115 may determine that the electronic device 110 is not within a transportation facility or within a predetermined distance of a transportation facility when the computing system 115 does not receive a beacon signal that has a signal strength that is above the signal strength threshold.

In certain embodiments, the computing system 115 of the electronic device 110 determines the location of the electronic device 110 using one or more global positioning systems (GPSs) or one or more wireless communication systems. For example, the computing system 115 to the electronic device 110 may use one or more GPSs or one or more wireless communication systems to determine that the electronic device 110 is located on a jetway or has been transported from a jetway into a transportation facility terminal. As another example, the computing system 115 of the electronic device 110 may use one or more GPSs or one or more wireless communication systems to determine that the electronic device 110 is located at a transportation facility gate or has been transported from the entrance to a transportation facility terminal to a transportation facility gate. As another example, the computing system 115 of the electronic device 110 may use one or more GPSs or one or more wireless communication systems to determine that the electronic device 110 is located at a particular position within a transport facility. As yet another example, the computing system 115 of the electronic device 110 may use one or more GPSs or one or more wireless communication systems to determine that the electronic device 110 is located at a security checkpoint. As yet another example, the computing system 115 of the electronic device 110 may use one or more GPS or one or more wireless communication systems to determine that the electronic device 110 is located near but outside a secured area of a transportation facility. As yet another example, the computing system 115 of the electronic device 110 may use one or more GPS or one or more wireless communication systems to determine that the electronic device 110 is located a distance away from a transportation facility (e.g., at a home or office of a user associated with a user account, on a road heading to a transportation facility).

At step 1607, the computing system 115 determines a duration of time between a current time and the one or more scheduled travel times. In certain embodiments, the computing system 115 may determine a duration of time from the current time to the one or more scheduled travel times. The computing system 115 may receive at least one of a transportation check-in time, a transportation boarding time, a transportation departure time, a transportation arrival time, or a transportation baggage pick-up time and determine the amount of time from the current time to at least one of the transportation check-in time, the transportation boarding time, the transportation departure time, a transportation arrival time, a transportation baggage pick-up time.

For example, the computing system 115 may determine an amount of time from a current time to an initial boarding time of a transport vehicle. As another example, the computing system 115 may determine an amount of time from a current time to a final boarding time of a transport vehicle. As yet another example, the computing system 115 may determine an amount of time from a current time to a time when a transport vehicle pushes away from a transportation facility gate. As yet another example, the computing system 115 may determine an amount of time from a current time to a time when a transport vehicle arrives at a transportation facility gate. As yet another example, the computing system 115 may determine an amount of time from a current time to a time when baggage will be available for retrieval at a transportation facility baggage claim area. As yet another example, the computing system 115 may determine an amount of time from a current time to a time when a passenger may be first able to check-in for a transportation activity.

At step 1609, the computing system 115 generates, for display on a display screen associated with the electronic device, one or more travel notifications based on the location of the electronic device, the duration of time, and the travel information. For example, the computing system 115 may determine that the electronic device 110 is located at a first gate of a transportation facility (e.g., having deplaned from an airplane located at the first gate). The computing system 115 may also determine, using received travel information, that the user of the user account associated with the electronic device 110 is to board an airplane through a second gate at the transportation facility 150 minutes from the current time. The computing system 115 may generate, for display on a display screen associated with the electronic device 110, a travel notification suggesting one or more merchant stores within the transportation facility that the user of the user account associated with the electronic device 110 has time to visit while still having time to board the airplane at the second gate before the airplane departs from the second gate. In certain embodiments, the one or more suggested merchant stores may be located along the route between the first gate of the transportation facility and the second gate of the transportation facility. In certain embodiments, the travel notification suggesting the one or more merchant stores may also be based on one or more preferences provided by and associated with a user of the user account.

As another example, the computing system 115 may determine that the electronic device 110 is located at a security checkpoint within a transportation facility. The computer system 115 may determine, using received travel information, that an amount of time from a current time to a final boarding time onto the transport vehicle is less than the threshold time. The computing system 115 may generate, for display on a display screen associated with the electronic device 110, a travel notification indicating that the transport vehicle is located at a particular transportation facility gate and is currently receiving fuel and maintenance and a travel notification indicating that an initial group of passengers will begin boarding the transport vehicle and 20 minutes.

As yet another example, the computing system 115 may determine that the electronic device 110 is located several miles from the transportation facility. The computer system 115 may determine, using received travel information, that an amount of time from a current time to a final boarding time onto the transport vehicle is less than the threshold time. The computing system 115 may generate, for display on a display screen associated with the electronic device 110, a travel notification suggesting that the user of the user account associated with the electronic device 110 depart from the current location of electronic device 110 within the next 30 minutes to board the transport vehicle before the transport vehicle departs. In certain embodiments, the computing system 115 may additionally or alternatively generate, for display on a display screen associated with the electronic device 110, a travel notification suggesting one or more particular parking garages at the transportation facility based on a level of occupancy and a proximity to a terminal or a gate from which the transport vehicle will depart. In certain embodiments, the computing system 115 may additionally or alternatively generate, for display on a display screen associated with the electronic device, a travel notification suggesting one or more particular security checkpoints having a wait time that is below a threshold wait time.

As yet another example, the computing system 115 may determine that the electronic device 110 is located several miles from the transportation facility. The computer system 115 may determine, using received travel information, that an amount of time from a current time to a final boarding time onto the transport vehicle is greater than the threshold time. The computing system 115 may generate, for display on a display screen associated with the electronic device 110, a travel notification suggesting that if the user of the user account associated with the electronic device 110 departs from the current location of electronic device 110 within the next 30 minutes for the transportation facility, the user of the user account associated with the electronic device 110 may have time to visit one or more merchant stores within the transportation facility. In certain embodiments, the computing system 115 may additionally or alternatively generate, for display on a display screen associated with the electronic device 110, a travel notification suggesting one or more lower-cost parking garages at the transportation facility that are further away from a terminal or a gate from which the transport vehicle will depart then one or more other parking garages at the transportation facility.

As yet another example, the computing system 115 may determine that the electronic device 110 is located at a gate of a transportation facility (e.g., having deplaned from an airplane located at the gate). The computing system 115 may also determine, using received travel information, that the user of the user account associated with the electronic device 110 is to arrive at the gate of the transportation facility at a time that is new later than the current time. The computing system 115 may further determine, using received travel information, that the user of the user account associated with the electronic device 110 has checked bags onto the airplane. Thus, the computing system 115 may determine that the user of the user account associated with the electronic device 110 may want to retrieve the bags at a baggage claim of the transportation facility. The computing system 115 may generate, for display on a display screen associated with the electronic device 110, a travel notification indicating a location of the baggage claim where the bags may be retrieved and directions from the gate of the transportation facility to the baggage claim where the bags may be retrieved. In certain embodiments, the computing system 115 may generate, for display on a display screen associated with the electronic device 110, a travel notification suggesting one or more merchant stores within the transportation facility that the user of the user account associated with the electronic device 110 may wish to visit before reaching the baggage claim. In certain embodiments, the one or more suggested merchant stores may be located along the route between the gate of the transportation facility and the baggage claim. In certain embodiments, the travel notification suggestions of the one or more merchant stores may also be based on one or more preferences provided by and associated with a user of the user account.

In certain embodiments, a travel notification may include at least one of a transportation status, an indication of a duration of time between the current time and a change of the transportation status, a recommended departure time from the location of the electronic device to a transportation departure location, an indication of a transportation departure location, an indication of one or more merchant locations between the location of the electronic device and a transportation departure location, an indication of a travel time from the location of the electronic device to one or more merchant locations, an indication of one or more baggage pick-up locations, an indication of a travel time from the location of the electronic device to one or more baggage pick-up locations, an indication of one or more suggested automobile parking locations, an indication of one or more suggested baggage drop-off locations, an indication of one or more user check-in locations, a current security wait time at one or more security check-points, an offer to view through the display screen associated with the electronic device at least one of an image or a video of a transportation departure location, a request to receive user feedback, an offer to receive transportation status updates, an offer to communicate with a customer service representative, an offer to generate an image of a transportation boarding pass, or the like.

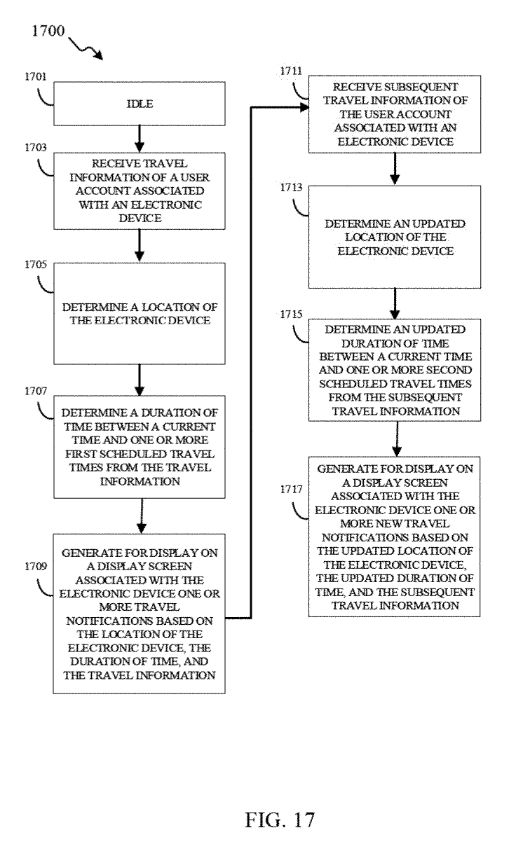

FIG. 17 illustrates a non-limiting, example method 1700 for performing one or more digital wayfinding operations according to certain embodiments of this disclosure. Although certain details will be provided with reference to the method 1700 of FIG. 17, it should be understood that other embodiments may include more, less, or different method steps. In certain embodiments, the method 1700 may be implemented by a computing system 115 of an electronic device 110. At step 1701, the computing system 115 is in an idle state at least with respect to performing one or more digital wayfinding operations. Step 1701 is at least similar to step 1601 of method 1600 illustrated in FIG. 16.

At step 1703, the computing system 115 receives travel information of a user account associated with the electronic device. The travel information may include one or more first scheduled travel times. Step 1703 is at least similar to step 1603 of method 1600 illustrated in FIG. 16. At step 1705, the computing system 115 determines a location of the electronic device. Step 1705 is at least similar to step 1605 of method 1600 illustrated in FIG. 16. At step 1707, the computing system 115 determines a duration of time between a current time and the one or more first scheduled travel times. Step 1707 is at least similar to step 1607 of method 1600 illustrated in FIG. 16. At step 1709, the computing system 115 generates, for display on a display screen associated with the electronic device, one or more travel notifications based on the location of the electronic device, the duration of time, and the travel information. Step 1709 is at least similar to step 1609 of method 1600 illustrated in FIG. 16.

At step 1711, the computing system 115 receives subsequent travel information of the user account associated with the electronic device. The subsequent travel information may include one or more second or subsequent scheduled travel times. The one or more second or subsequent scheduled travel times may also include at least one of a transportation check-in time, a transportation boarding time, a transportation departure time, a transportation arrival time, a transportation baggage pick-up time, or the like. In certain embodiments, the subsequent travel information may further include at least one of a user name, a user status, a user travel code, a user travel preference, a transportation identification, a departure location, an arrival location, a transportation boarding classification, a baggage pick-up location, or the like. The computing system 115 may receive the subsequent travel information using one or more same or similar systems and methods described herein with respect to the travel information and from one or more same or similar sources (e.g., through a user input interface, from the one or more servers 102) described herein with respect to the travel information. In certain embodiments, the subsequent travel information may include at least one of a user name, a user status, a user travel code, a user travel preference, a transportation identification, a departure location, an arrival location, a transportation boarding classification, or a baggage pick-up location.

In certain embodiments, the one or more second or subsequent scheduled travel times include at least one different scheduled travel time from the one or more scheduled travel times. For example, the computing system 115 may use the at least one different scheduled travel time to generate for display a new travel notification. The new travel notification may be populated in the boarding status field 614 of the user interface home display 600 illustrated in FIG. 6 and may recite, for example, “Boarding Now: A-Group.” In certain embodiments, the subsequent travel information may include at least one change of travel information from immediately preceding received travel information. Step 1711 may be at least similar to step 1603 of method 1600 illustrated in FIG. 16.

At step 1713, the computing system 115 determines an updated location of the electronic device. For example, after the computing system 115 receives the subsequent travel information of the user account associated with the electronic device 110, the computing system 115 may determine an updated location of the electronic device 110. The computing system 115 may determine the updated location of the electronic device 110 using one or more same or similar electronic device location determination methods and systems described herein. Step 1713 may be at least similar to step 1605 of method 1600 illustrated in FIG. 16.

At step 1715, the computing system 115 determines an updated duration of time between a current time and the one or more second scheduled travel times. For example, after the computing system 115 receives the subsequent travel information of the user account associated with the electronic device 110, the computing system 115 may determine an updated duration of time between a current time and the one or more subsequent or second scheduled travel times. The computing system 115 may determine the updated duration of time using one or more same or similar duration of time determination methods or systems described herein. Step 1715 may be at least similar to step 1607 of method 1600 illustrated in FIG. 16.

At step 1717, the computing system 115 generates for display on a display screen associated with the electronic device one or more new travel notifications based on the updated location of the electronic device, the updated duration of time, and the subsequent travel information. For example, after the computing system 115 receives the subsequent travel information of the user account associated with the electronic device 110, determines the update location of the electronic device 110, and determines an updated duration of time, the computing system 115 may determine generate, for display on a display screen associated with the electronic device 110, one or more new travel notifications. The one or more new travel notifications may include at least one of a transportation status, an indication of a duration of time between the current time and a change of the transportation status, a recommended departure time from the location of the electronic device to a transportation departure location, an indication of a transportation departure location, an indication of one or more merchant locations between the location of the electronic device and a transportation departure location, an indication of a travel time from the location of the electronic device to one or more merchant locations, an indication of one or more baggage pick-up locations, an indication of a travel time from the location of the electronic device to one or more baggage pick-up locations, an indication of one or more suggested automobile parking locations, an indication of one or more suggested baggage drop-off locations, an indication of one or more user check-in locations, a current security wait time at one or more security check-points, an offer to view through the display screen associated with the electronic device at least one of an image or a video of a transportation departure location, a request to receive user feedback, an offer to receive transportation status updates, an offer to communicate with a customer service representative, an offer to generate an image of a transportation boarding pass, or the like. The computing system 115 may generate, for display on a display screen of the electronic device 110, the one or more new travel notification using one or more same or similar methods or systems to generate the travel notifications described herein. In certain embodiments, new travel notifications may include at least one changed travel notification from immediately preceding generated travel notifications. Step 1717 may be at least similar to step 1609 of method 1600 illustrated in FIG. 16.

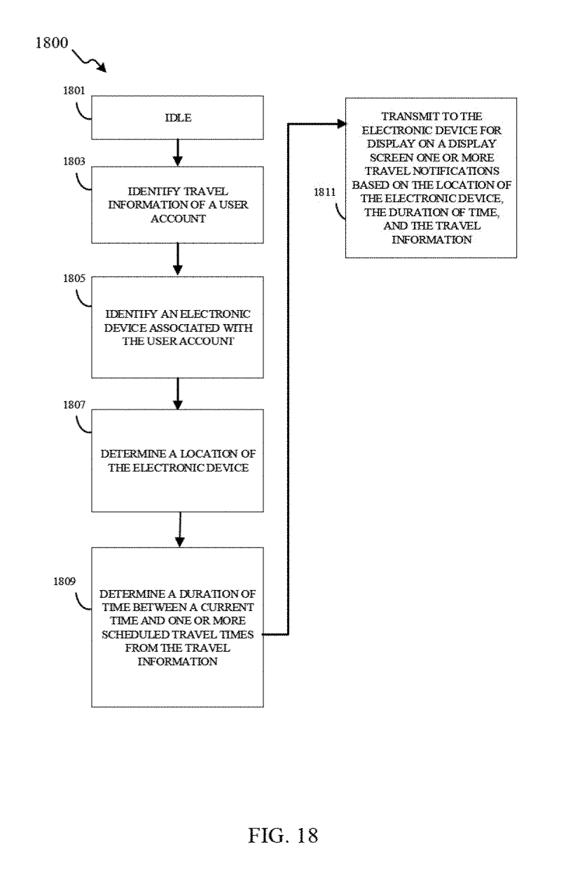

FIG. 18 illustrates a non-limiting, example method 1800 for performing one or digital wayfinding operations according to certain embodiments of this disclosure. Although certain details will be provided with reference to the method 1800 of FIG. 18, it should be understood that other embodiments may include more, less, or different method steps. In certain embodiments, the method 1800 may be implemented by one or more processors of a server (e.g., the one or more servers 120, the server 204). At step 1801, the one or more processors are in an idle state at least with respect to performing one or more digital wayfinding operations.

At step 1803, the one or more processors identify travel information of a user account. In certain embodiments, the one or more servers 120 may generate travel information based on at least one of one or more items of user account information, one or more items of transportation information, one or more items of commuting information, one or more items of departure facility traffic information, or one or more items of departure facility information as described and identify travel information for a user account associated with an electronic device 110.

The one or more servers 120 may generate travel information associated with the user account based on at least one of one or more items of user account information, one or more items of transportation information, one or more items of commuting information, one or more items of departure facility traffic information, or one or more items of departure facility information. The one or more servers 120 may transmit the travel information of the user account to the electronic device 110 so that the electronic device 110 performs one or more digital wayfinding operations. In certain embodiments, the one or more servers 120 may transmit the travel information of the user account and including one or more scheduled travel times to the electronic device 110 so that the electronic device 110 performs one or more digital wayfinding operations.

In certain embodiments, the computing system 115 may receive travel information from the one or more servers 120 that includes one or more scheduled travel times. For example, one or more scheduled travel times may include at least one of a transportation check-in time, a transportation boarding time, a transportation departure time, a transportation arrival time, a transportation baggage pick-up time, or the like. In certain embodiments, the travel information further includes at least one of a user name, a user status, a user travel code, a user travel preference, a transportation identification, a departure location, an arrival location, a transportation boarding classification, a baggage pick-up location, or the like.

At step 1805, the one or more processors identify an electronic device associated with the user account. For example, after the one or more servers 120 receive at least one of one or more items of user account information, one or more items of transportation information, one or more items of commuting information, one or more items of departure facility traffic information, or one or more items of departure facility information, the one or more servers 120 may identify travel information associated with a user account and identify an electronic device 110 associated with the user account for information within the user account.

At step 1807, the one or more processors determine a location of the electronic device. For example, after identifying an electronic device 110 associated with a user account and travel information, the one or more processors may transmit a signal to the electronic device 110 requesting an indication of a location of the electronic device 110. In response to transmitting the signal, the one or more processors may receive a response message from the electronic device 110 including an indication of the location of the electronic device 110.

At step 1809, the one or more processors determine a duration of time between a current time and the one or more scheduled travel times. For example, the one or more processors may include a clock that provides a current date and time. The one or more processors may receive at least one of a transportation check-in time, a transportation boarding time, a transportation departure time, a transportation arrival time, or a transportation baggage pick-up time and determine the amount of time from the current time to at least one of the transportation check-in time, the transportation boarding time, the transportation departure time, a transportation arrival time, a transportation baggage pick-up time and compare at least one of those times with the current time to determine the duration of time between the current time and one or more schedule travel times.

At step 1811, the one or more processors may generate and transmit (e.g., direct a transmission of) one or more travel notifications to the electronic device for display on a display screen based on the location of the electronic device, the duration of time, and the travel information. For example, the one or more processors may determine that the electronic device 110 is located at a first gate of a transportation facility (e.g., having deplaned from an airplane located at the first gate). The one or more processors may also determine, using received travel information, that the user of the user account associated with the electronic device 110 is to board an airplane through a second gate at the transportation facility 150 minutes from the current time. The one or more processors may generate and transmit, for display on a display screen associated with the electronic device 110, a travel notification suggesting one or more merchant stores within the transportation facility that the user of the user account associated with the electronic device 110 has time to visit while still having time to board the airplane at the second gate before the airplane departs from the second gate. In certain embodiments, the one or more suggested merchant stores may be located along the route between the first gate of the transportation facility and the second gate of the transportation facility. In certain embodiments, the travel notification suggesting the one or more merchant stores may also be based on one or more preferences provided by and associated with a user of the user account.

As another example, the one or more processors may determine that the electronic device 110 is located at a security checkpoint within a transportation facility. The one or more processors may determine, using received travel information, that an amount of time from a current time to a final boarding time onto the transport vehicle is less than the threshold time. The computing system 115 may generate and transmit, for display on a display screen associated with the electronic device 110, a travel notification indicating that the transport vehicle is located at a particular transportation facility gate and is currently receiving fuel and maintenance and a travel notification indicating that an initial group of passengers will begin boarding the transport vehicle and 20 minutes.

As yet another example, the one or more processors may determine that the electronic device 110 is located several miles from the transportation facility. The one or more processors may determine, using received travel information, that an amount of time from a current time to a final boarding time onto the transport vehicle is less than the threshold time. The one or more processors may generate and transmit, for display on a display screen associated with the electronic device 110, a travel notification suggesting that the user of the user account associated with the electronic device 110 depart from the current location of electronic device 110 within the next 30 minutes to board the transport vehicle before the transport vehicle departs. In certain embodiments, the one or more processors may additionally or alternatively generate and transmit, for display on a display screen associated with the electronic device 110, a travel notification suggesting one or more particular parking garages at the transportation facility based on a level of occupancy and a proximity to a terminal or a gate from which the transport vehicle will depart. In certain embodiments, the one or more processors may additionally or alternatively generate and transmit, for display on a display screen associated with the electronic device, a travel notification suggesting one or more particular security checkpoints having a wait time that is below a threshold wait time.

As yet another example, the one or more processors may determine that the electronic device 110 is located several miles from the transportation facility. The one or more processors may determine, using received travel information, that an amount of time from a current time to a final boarding time onto the transport vehicle is greater than the threshold time. The one or more processors may generate and transmit, for display on a display screen associated with the electronic device 110, a travel notification suggesting that if the user of the user account associated with the electronic device 110 departs from the current location of electronic device 110 within the next 30 minutes for the transportation facility, the user of the user account associated with the electronic device 110 may have time to visit one or more merchant stores within the transportation facility. In certain embodiments, the one or more processors may additionally or alternatively generate and transmit, for display on a display screen associated with the electronic device 110, a travel notification suggesting one or more lower-cost parking garages at the transportation facility that are further away from a terminal or a gate from which the transport vehicle will depart then one or more other parking garages at the transportation facility.

As yet another example, the one or more processors may determine that the electronic device 110 is located at a gate of a transportation facility (e.g., having deplaned from an airplane located at the gate). The one or more processors may also determine, using travel information, that the user of the user account associated with the electronic device 110 is to arrive at the gate of the transportation facility at a time that is new later than the current time. The one or more processors may further determine, using travel information, that the user of the user account associated with the electronic device 110 has checked bags onto the airplane. Thus, the one or more processors may determine that the user of the user account associated with the electronic device 110 may want to retrieve the bags at a baggage claim of the transportation facility. The one or more processors may generate and transmit, for display on a display screen associated with the electronic device 110, a travel notification indicating a location of the baggage claim where the bags may be retrieved and directions from the gate of the transportation facility to the baggage claim where the bags may be retrieved. In certain embodiments, one or more processors may generate and transmit, for display on a display screen associated with the electronic device 110, a travel notification suggesting one or more merchant stores within the transportation facility that the user of the user account associated with the electronic device 110 may wish to visit before reaching the baggage claim. In certain embodiments, the one or more suggested merchant stores may be located along the route between the gate of the transportation facility and the baggage claim. In certain embodiments, the travel notification suggestions of the one or more merchant stores may also be based on one or more preferences provided by and associated with a user of the user account.

In certain embodiments, a travel notification may include at least one of a transportation status, an indication of a duration of time between the current time and a change of the transportation status, a recommended departure time from the location of the electronic device to a transportation departure location, an indication of a transportation departure location, an indication of one or more merchant locations between the location of the electronic device and a transportation departure location, an indication of a travel time from the location of the electronic device to one or more merchant locations, an indication of one or more baggage pick-up locations, an indication of a travel time from the location of the electronic device to one or more baggage pick-up locations, an indication of one or more suggested automobile parking locations, an indication of one or more suggested baggage drop-off locations, an indication of one or more user check-in locations, a current security wait time at one or more security check-points, an offer to view through the display screen associated with the electronic device at least one of an image or a video of a transportation departure location, a request to receive user feedback, an offer to receive transportation status updates, an offer to communicate with a customer service representative, an offer to generate an image of a transportation boarding pass, or the like.

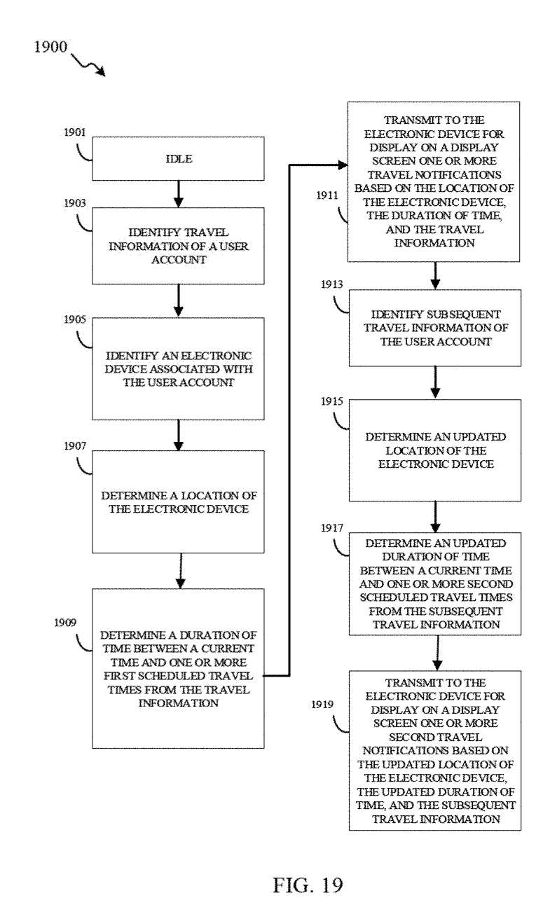

FIG. 19 illustrates a non-limiting, example method 1900 for performing one or more digital wayfinding operations according to certain embodiments of this disclosure. Although certain details will be provided with reference to the method 1900 of FIG. 19, it should be understood that other embodiments may include more, less, or different method steps. In certain embodiments, the method 1900 may be implemented by one or more processors of a server (e.g., the one or more servers 120, the server 204). At step 1901, the one or more processors are in an idle state at least with respect to performing one or more digital wayfinding operations. Step 1901 is at least similar to step 1801 of method 1800 illustrated in FIG. 18. At step 1903, the one or more processors identify travel information of a user account. The travel information may include one or more first scheduled travel times. Step 1903 is at least similar to step 1803 of method 1800 illustrated in FIG. 18. At step 1905, the one or more processors identify an electronic device associated with the user account. Step 1905 is at least similar to step 1805 of method 1800 illustrated in FIG. 18. At step 1907, the one or more processors determine a location of the electronic device. Step 1907 is at least similar to step 1807 of method 1800 illustrated in FIG. 18. At step 1909, the one or more processors determine a duration of time between a current time and the one or more first scheduled travel times. Step 1909 is at least similar to step 1809 of method 1800 illustrated in FIG. 18. At step 1911, the one or more processors transmit (e.g., direct a transmission of) one or more travel notifications to the electronic device for display on a display screen based on the location of electronic device, the duration of time, and the travel information. Step 1911 is at least similar to step 1811 of method 1800 illustrated in FIG. 18.

At step 1913, the one or more processors identify subsequent travel information of the user account. The subsequent travel information may include one or more second or subsequent scheduled travel times. The one or more second or subsequent scheduled travel times may also include at least one of a transportation check-in time, a transportation boarding time, a transportation departure time, a transportation arrival time, a transportation baggage pick-up time, or the like. In certain embodiments, the subsequent travel information may further include at least one of a user name, a user status, a user travel code, a user travel preference, a transportation identification, a departure location, an arrival location, a transportation boarding classification, a baggage pick-up location, or the like. The one or more processors may identify the subsequent travel information using one or more same or similar systems and methods described herein with respect to the travel information and from one or more same or similar sources described herein with respect to the travel information. In certain embodiments, the subsequent travel information may include at least one of a user name, a user status, a user travel code, a user travel preference, a transportation identification, a departure location, an arrival location, a transportation boarding classification, or a baggage pick-up location.

In certain embodiments, the one or more second or subsequent scheduled travel times include at least one different scheduled travel time from the one or more scheduled travel times. For example, the computing system 115 may use the at least one different scheduled travel time to generate for display a new travel notification. The new travel notification may be populated in the boarding status field 614 of the user interface home display 600 illustrated in FIG. 6 and may recite, for example, “Boarding Now: A-Group.” In certain embodiments, the subsequent travel information may include at least one change of travel information from immediately preceding received travel information. Step 1913 may be at least similar to step 1803 of method 1800 illustrated in FIG. 18.

At step 1915, the one or more processors determine an updated location of the electronic device. For example, after the one or more processors identify the subsequent travel information of the user account associated with the electronic device 110, the one or more processors may determine an updated location of the electronic device 110. The one or more processors may determine the updated location of the electronic device 110 using one or more same or similar electronic device location determination methods and systems described herein. Step 1915 may be at least similar to step 1807 of method 1800 illustrated in FIG. 18.

At step 1917, the one or more processors determine an updated duration of time between a current time in the one or more second scheduled travel times. For example, after the one or more processors identify the subsequent travel information of the user account associated with the electronic device 110, the one or more processors may determine an updated duration of time between a current time and the one or more subsequent or second scheduled travel times. The one or more processors may determine the updated duration of time using one or more same or similar duration of time determination methods or systems described herein. Step 1917 may be at least similar to step 1809 of method 1800 illustrated in FIG. 18.

At step 1919, the one or more processors transmit (e.g., direct the transmission of) one or more second travel notifications to the electronic device for display on a display screen based on the updated location of the electronic device, the updated duration of time, and the subsequent travel information. For example, after the one or more processors identify the subsequent travel information of the user account associated with the electronic device 110, determine the update location of the electronic device 110, and determine an updated duration of time, the one or more processors may determine generate and transmit, for display on a display screen associated with the electronic device 110, one or more new travel notifications. The one or more new travel notifications may include at least one of a transportation status, an indication of a duration of time between the current time and a change of the transportation status, a recommended departure time from the location of the electronic device to a transportation departure location, an indication of a transportation departure location, an indication of one or more merchant locations between the location of the electronic device and a transportation departure location, an indication of a travel time from the location of the electronic device to one or more merchant locations, an indication of one or more baggage pick-up locations, an indication of a travel time from the location of the electronic device to one or more baggage pick-up locations, an indication of one or more suggested automobile parking locations, an indication of one or more suggested baggage drop-off locations, an indication of one or more user check-in locations, a current security wait time at one or more security check-points, an offer to view through the display screen associated with the electronic device at least one of an image or a video of a transportation departure location, a request to receive user feedback, an offer to receive transportation status updates, an offer to communicate with a customer service representative, an offer to generate an image of a transportation boarding pass, or the like. The one or more processors may generate and transmit, for display on a display screen of the electronic device 110, the one or more new travel notification using one or more same or similar methods or systems to generate the travel notifications described herein. In certain embodiments, new travel notifications may include at least one changed travel notification from immediately preceding generated travel notifications. Step 1919 may be at least similar to step 1811 of method 1800 illustrated in FIG. 18.

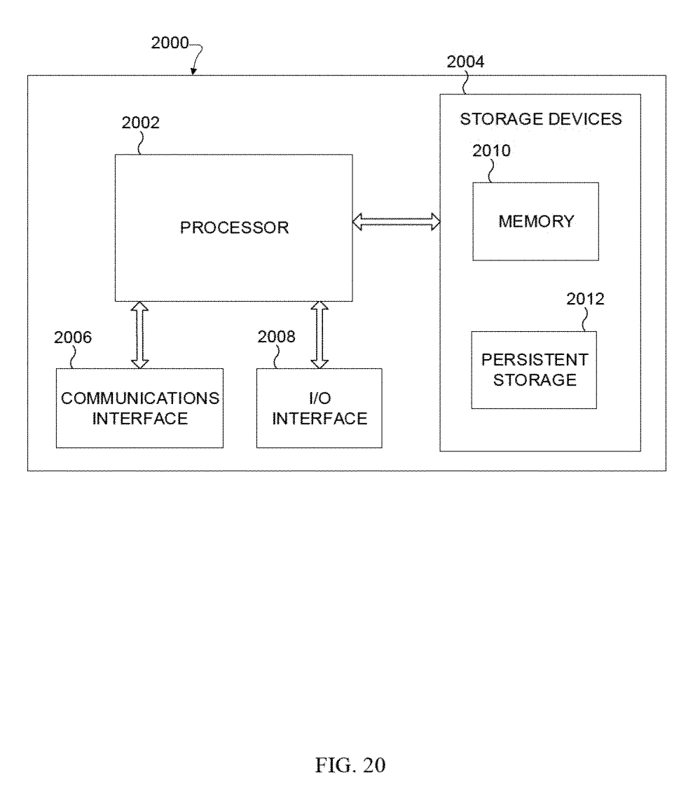

FIG. 20 illustrates a non-limiting, example device 2000 supporting the depiction and usage of one logical connection with a collection of I/O modules as multiple individual logical connections according to certain embodiments of this disclosure. The device 2000 could, for example, represent the one or more servers 120, the server 204, one of the nodes 1-8, an electronic device 110, one or more of the mobile devices 210a, 210b, 210c, or 210d, may be part of the network 105 of FIG. 1, or may be part of the network 202 of FIG. 2.

As shown in FIG. 20, the device 2000 includes at least one processor 2002, at least one storage device 2004, at least one communications interface 2006, and at least one input/output (I/O) interface 2008. The processor 2002 executes instructions that may be loaded into a memory 2010, such as instructions that (when executed by the processor 2002) are implemented on an electronic device (e.g., an electronic device 110, one or more mobile devices 210a, 210b, 210c, and 210d) or a server (e.g., the one or more servers 102, the server 204). The processor 2002 includes any suitable number(s) and type(s) of processors or other processing devices in any suitable arrangement. Example types of processors 2002 include microprocessors, microcontrollers, digital signal processors, field programmable gate arrays, application specific integrated circuits, and discrete circuitry.

The memory device 2010 and a persistent storage 2012 are examples of storage devices 2004, which represent any structure(s) capable of storing and facilitating retrieval of information (such as data, program code, and/or other suitable information on a temporary or permanent basis). The memory device 2010 may represent a random access memory or any other suitable volatile or non-volatile storage device(s). The persistent storage 2012 may contain one or more components or devices supporting longer-term storage of data, such as a read only memory, hard drive, Flash memory, or optical disc.

The communications interface 2006 supports communications with other systems or devices. For example, the communications interface 2006 could include a network interface card or a wireless transceiver facilitating communications over a wired or wireless network. The communications interface 2006 may support communications through any suitable physical or wireless communication link(s). Note, however, that the use of the communications interface 2006 may not be needed, such as when the device 2000 processes data locally and does not need to engage in network communications.

The I/O interface 2008 allows for input and output of data. For example, the I/O interface 2008 may provide a connection for user input through a keyboard, mouse, keypad, touchscreen, or other suitable input device. The I/O interface 2008 may also send output to a display, printer, or other suitable output device. Note, however, that the use of the I/O interface 2008 for local I/O may not be needed, such as when the device 2000 is accessible locally or remotely over a network connection.

Although FIG. 20 illustrates one example of a device 2000 supporting the depiction and usage of one logical connection with a collection of I/O modules as multiple individual logical connections, various changes may be made to FIG. 20. For example, computing devices come in a wide variety of configurations, and FIG. 20 does not limit this disclosure to any particular computing device.

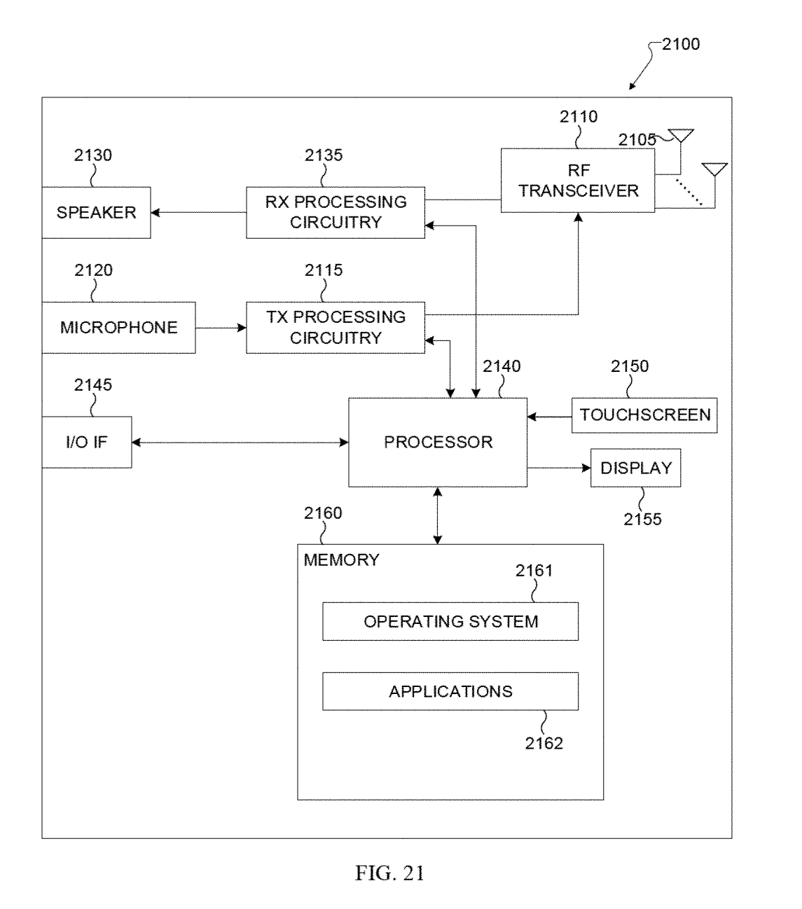

FIG. 21 illustrates a non-limiting, example mobile device 2100 according to certain embodiments of this disclosure. The mobile device 2100 could, for example, represent an electronic device 110 of FIGS. 1 and 3 or one of the mobile devices 210a, 210b, 210c, and 210d of FIG. 2. As shown in FIG. 21, the mobile device 2100 includes an antenna 2105, a radio frequency (RF) transceiver 2110, TX processing circuitry 2115, a microphone 2120, and receive (RX) processing circuitry 2125. The mobile device 2100 also includes a speaker 2130, a processor 2140, an input/output (I/O) interface (IF) 2145, a touchscreen 2150, a display 2155, and a memory 2160. The memory 2160 includes an operating system (OS) 2161 and one or more applications 2162.

The RF transceiver 2110 receives, from the antenna 2105, an incoming RF signal transmitted by the network 105 of FIG. 1 or the network 202 of FIG. 2. The RF transceiver 2110 down-converts the incoming RF signal to generate an intermediate frequency (IF) or baseband signal. The IF or baseband signal is sent to the RX processing circuitry 2125, which generates a processed baseband signal by filtering, decoding, and/or digitizing the baseband or IF signal. The RX processing circuitry 2125 transmits the processed baseband signal to the speaker 2130 (such as for voice data) or to the processor 2140 for further processing (such as for web browsing data).

In some embodiments, the RF transceiver 2110 is capable of transmitting the short PUCCH using the number of OFDM symbols based on the identified position. In such embodiments, the number of OFDM symbols is dynamically or semi-statically allocated by a higher layer signaling received from the eNB, the number of OFDM symbols being determined by a positive integer number.

The TX processing circuitry 2115 receives analog or digital voice data from the microphone 2120 or other outgoing baseband data (such as web data, e-mail, or interactive video game data) from the processor 2140. The TX processing circuitry 315 encodes, multiplexes, and/or digitizes the outgoing baseband data to generate a processed baseband or IF signal. The RF transceiver 2110 receives the outgoing processed baseband or IF signal from the TX processing circuitry 2115 and up-converts the baseband or IF signal to an RF signal that is transmitted via the antenna 2105.

The processor 2140 can include one or more processors or other processing devices and execute the OS 2161 stored in the memory 2160 in order to control the overall operation of the mobile device 2100. For example, the processor 2140 could control the reception of forward channel signals and the transmission of reverse channel signals by the RF transceiver 2110, the RX processing circuitry 2125, and the TX processing circuitry 2115 in accordance with well-known principles. In some embodiments, the processor 2140 includes at least one microprocessor or microcontroller.

The processor 2140 is also capable of executing other processes and programs resident in the memory 2160, such as digital wayfinding operations described herein. The processor 2140 can move data into or out of the memory 2160 as required by an executing process. In some embodiments, the processor 2140 is configured to execute the applications 2162 based on the OS 2161 or in response to signals received from an operator. The processor 2140 is also coupled to the I/O interface 2145, which provides the mobile device with the ability to connect to other devices, such as laptop computers and handheld computers. The I/O interface 2145 is the communication path between these accessories and the processor 2140.

The processor 2140 may also be coupled to the touchscreen 2150 and the display 2155. The operator of the mobile device 2100 can use the touchscreen 2150 to enter data into the mobile device 2100. The display 2155 may be a liquid crystal display, light emitting diode display, or other display capable of rendering text and/or at least limited graphics, such as from web sites.

The memory 2160 is coupled to the processor 2140. Part of the memory 2160 could include a random access memory (RAM), and another part of the memory 2160 could include a Flash memory or other read-only memory (ROM).

Although FIG. 21 illustrates one example of mobile device 2100, various changes may be made to FIG. 21. For example, various components in FIG. 21 could be combined, further subdivided, or omitted and additional components could be added according to particular needs. As a particular example, the processor 2140 could be divided into multiple processors, such as one or more central processing units (CPUs) and one or more graphics processing units (GPUs). Also, while FIG. 21 illustrates the mobile device 2100 configured as a mobile telephone or smartphone, mobile devices could be configured to operate as other types of mobile or stationary devices.

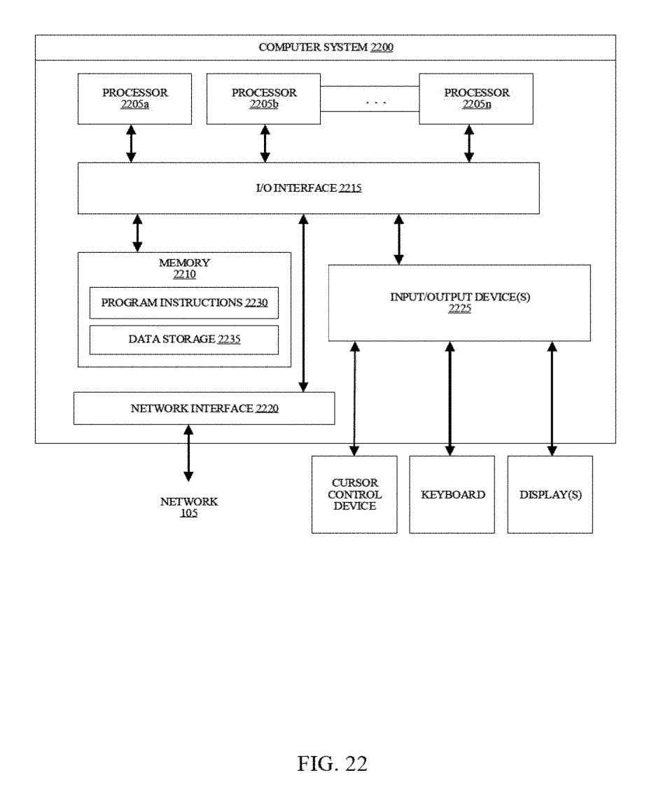

FIG. 22 illustrates a non-limiting, example computer system 2200 configured to implement systems and methods for performing one or more interactive gaming operations according to certain embodiments of this disclosure. FIG. 22 illustrates a computer system 2200 that is configured to execute any and all of the embodiments described herein. In certain embodiments, the computer system 2200 describes at least some of the components of electronic device 110 or the computing system 115 illustrated in FIGS. 1 and 3. In certain embodiments, the computer system 2200 describes at least some of the components of mobile devices 210a, 210b, 210c, and 210d illustrated in FIG. 2. In certain embodiments, the computer system 2200 describes at least some of the components of one or more servers 120 illustrated in FIG. 1 or the server 204 illustrated in FIG. 2. In different embodiments, the computer system 2200 may be any of various types of devices, including, but not limited to, a computer embedded in a vehicle, a computer embedded in an appliance, a personal computer system, a desktop computer, a handset (e.g., a laptop computer, a notebook computer, a tablet, a slate, a netbook computer, a camera, a handheld video game device, a handheld computer, a video recording device, a consumer device, a portable storage device, or the like), a mainframe computer system, a workstation, network computer, a set top box, a video game console, a mobile device, an application server, a storage device, a television, a peripheral device such as a switch, modem, router, or in general any type of computing or electronic device.

Various embodiments of a system and method for digital wayfinding operations, as described herein, may be executed on one or more computer systems 2200, which may interact with various other devices. In the illustrated embodiment, the computer system 2200 includes one or more processors 2205 coupled to a system memory 2210 via an input/output (I/O) interface 2215. The computer system 2200 further includes a network interface 2220 coupled to I/O interface 2215, and one or more input/output devices 2225, such as cursor control device, keyboard, and display(s). In some cases, it is contemplated that embodiments may be implemented using a single instance of computer system 2200, while in other embodiments multiple such systems, or multiple nodes making up computer system 2200, may be configured to host different portions or instances of embodiments. For example, in one embodiment some elements may be implemented via one or more nodes of computer system 2200 that are distinct from those nodes implementing other elements.

In various embodiments, computer system 2200 may be a uniprocessor system including one processor 2205a, or a multiprocessor system including several processors 2205a-2205n (e.g., two, four, five, eight, or another suitable number). The processors 2205 may be any suitable processor capable of executing instructions. For example, in various embodiments the processors 2205 may be general-purpose or embedded processors implementing any of a variety of instruction set architectures (ISAs), such as the x86, PowerPC, SPARC, or MIPS ISAs, or any other suitable ISA. In multiprocessor systems, each of processors 2205 may commonly, but not necessarily, implement the same ISA.

The system memory 2210 may be configured to store the program instructions 2230 and/or existing state information and ownership transition condition data in the data storage 2235 accessible by the processor 2205. In various embodiments, the system memory 2210 may be implemented using any suitable memory technology, such as static random access memory (SRAM), synchronous dynamic RAM (SDRAM), nonvolatile/Flash-type memory, or any other type of memory. In the illustrated embodiment, the program instructions 2230 may be configured to implement a system for performing one or more digital wayfinding operations incorporating any of the functionality, as described herein. In some embodiments, program instructions and/or data may be received, sent, or stored upon different types of computer-accessible media or on similar media separate from the system memory 2210 or the computer system 2200. The computer system 2200 is described as implementing at least some of the functionality of functional blocks of previous Figures.

In one embodiment, the I/O interface 2215 may be configured to coordinate I/O traffic between the processor 2205, the system memory 2210, and any peripheral devices in the device, including the network interface 2220 or other peripheral interfaces, such as the input/output devices 2225. In some embodiments, the I/O interface 2215 may perform any necessary protocol, timing or other data transformations to convert data signals from one component (e.g., the system memory 2210) into a format suitable for use by another component (e.g., the processor 2205). In some embodiments, the I/O interface 2215 may include support for devices attached through various types of peripheral buses, such as a variant of the Peripheral Component Interconnect (PCI) bus standard or the Universal Serial Bus (USB) standard, for example. In some embodiments, the function of the I/O interface 2215 may be split into two or more separate components, such as a north bridge and a south bridge, for example. Also, in some embodiments some or all of the functionality of the I/O interface 2215, such as an interface to the system memory 2210, may be incorporated directly into the processor 2205.

The network interface 2220 may be configured to allow data to be exchanged between the computer system 2200 and other devices attached to a network (e.g., the network 105, the network 202) or between nodes of the computer system 2200. The network 105 or the network 202 may in various embodiments include one or more networks including but not limited to Local Area Networks (LANs) (e.g., an Ethernet or corporate network), Wide Area Networks (WANs) (e.g., the Internet), wireless data networks, some other electronic data network, a combination thereof, or the like. In various embodiments, the network interface 2220 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

The input/output devices 2225 may, in some embodiments, include one or more display terminals, keyboards, keypads, touchpads, scanning devices, voice, or optical recognition devices, or any other devices suitable for entering or accessing data by one or more the computer systems 2200. Further, various other sensors may be included in the I/O devices 2225, such as imaging sensors, barometers, altimeters, LIDAR, or any suitable environmental sensor. Multiple input/output devices 2225 may be present in the computer system 2200 or may be distributed on various nodes of the computer system 2200. In some embodiments, similar input/output devices may be separate from the computer system 2200 and may interact with one or more nodes of the computer system 2200 through a wired or wireless connection, such as over the network interface 2220.

As shown in FIG. 22, the memory 2210 may include program instructions 2230, which may be processor-executable to implement any element or action described herein. In one embodiment, the program instructions may implement at least a portion of methods described herein, such as the methods illustrated by FIGS. 16-19. In other embodiments, different elements and data may be included. Note that the data storage 2235 may include any data or information described herein.

Those skilled in the art will appreciate that the computer system 2200 is merely illustrative and is not intended to limit the scope of embodiments. In particular, the computer system and devices may include any combination of hardware or software that can perform the indicated functions, including computers, network devices, Internet appliances, PDAs, wireless phones, pagers, GPUs, specialized computer systems, information handling apparatuses, or the like. The computer system 2200 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions, structured data) on a computer-accessible medium or a portable article to be read by an appropriate drive, various examples of which are described here. In some embodiments, instructions stored on a computer-accessible medium separate from the computer system 2200 may be transmitted to the computer system 2200 through transmission media or signals such as electrical, electromagnetic, or digital signals, conveyed via a communication medium such as a network and/or a wireless link. Various embodiments may further include receiving, sending, or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g., SDRAM, DDR, RDRAM, SRAM, or the like), ROM, or the like. In some embodiments, a computer-accessible medium may include transmission media or signals such as electrical, electromagnetic, or digital signals, conveyed via a communication medium such as network and/or a wireless link.

Thus, the disclosure provides, among other things, a system for executing one or more digital wayfinding operations, including a computing system or a computer system. None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. An electronic device comprising:
a computing system including a memory and at least one processor, wherein the computing system is configured to:
receive travel information of a user account associated with the electronic device, wherein the travel information includes one or more scheduled travel times,
determine a location of the electronic device,
determine a duration of time between a current time and the one or more scheduled travel times, and
generate, for display on a display screen associated with the electronic device, one or more travel notifications based on the location of the electronic device, the duration of time, and the travel information.

2. The electronic device of claim 1, wherein the travel information further includes at least one of a user name, a user status, a user travel code, a user travel preference, a transportation identification, a departure location, an arrival location, a transportation boarding classification, or a baggage pick-up location.

3. The electronic device of claim 1, wherein the one or more scheduled travel times include at least one of a transportation check-in time, a transportation boarding time, a transportation departure time, a transportation arrival time, or a transportation baggage pick-up time.

4. The electronic device of claim 1, wherein the one or more travel notifications include at least one of a transportation status, an indication of a duration of time between the current time and a change of the transportation status, a recommended departure time from the location of the electronic device to a transportation departure location, an indication of a transportation departure location, an indication of one or more merchant locations between the location of the electronic device and a transportation departure location, an indication of a travel time from the location of the electronic device to one or more merchant locations, an indication of one or more baggage pick-up locations, an indication of a travel time from the location of the electronic device to one or more baggage pick-up locations, an indication of one or more suggested automobile parking locations, an indication of one or more suggested baggage drop-off locations, an indication of one or more user check-in locations, a current security wait time at one or more security check-points, an offer to view through the display screen associated with the electronic device at least one of an image or a video of a transportation departure location, a request to receive user feedback, an offer to receive transportation status updates, an offer to communicate with a customer service representative, or an offer to generate an image of a transportation boarding pass.

5. The electronic device of claim 1, wherein the travel information comprises aircraft travel information.

6. The electronic device of claim 1, wherein the one or more scheduled travel times is one or more first scheduled travel times, and wherein after the computing system generates, for display on the display screen associated with the electronic device, the one or more travel notifications, the computing system is further configured to:
receive subsequent travel information of the user account associated with the electronic device, wherein the subsequent travel information includes one or more second scheduled travel times;
determine an updated location of the electronic device;
determine an updated duration of time between a current time and the one or more second scheduled travel times; and
generate, for display on the display screen associated with the electronic device, one or more new travel notifications based on the updated location of the electronic device, the updated duration of time, and the subsequent travel information.

7. The electronic device of claim 6, wherein the one or more second scheduled travel times include at least one different scheduled travel time from the one or more first scheduled travel times.

8. A method implemented by a computing system of an electronic device, the method comprising:
receiving, by the computing system, travel information of a user account associated with the electronic device, wherein the travel information includes one or more scheduled travel times;
determining, by the computing system, a location of the electronic device;
determining, by the computing system, a duration of time between a current time and the one or more scheduled travel times; and
generating, by the computing system for display on a display screen associated with the electronic device, one or more travel notifications based on the location of the electronic device, the duration of time, and the travel information.

9. The method of claim 8, wherein the travel information further includes at least one of a user name, a user status, a user travel code, a user travel preference, a transportation identification, a departure location, an arrival location, a transportation boarding classification, or a baggage pick-up location.

10. The method of claim 8, wherein the one or more scheduled travel times include at least one of a transportation check-in time, a transportation boarding time, a transportation departure time, a transportation arrival time, or a transportation baggage pick-up time.

11. The method of claim 8, wherein the one or more travel notifications include at least one of a transportation status, an indication of a duration of time between the current time and a change of the transportation status, a recommended departure time from the location of the electronic device to a transportation departure location, an indication of a transportation departure location, an indication of one or more merchant locations between the location of the electronic device and a transportation departure location, an indication of a travel time from the location of the electronic device to one or more merchant locations, an indication of one or more baggage pick-up locations, an indication of a travel time from the location of the electronic device to one or more baggage pick-up locations, an indication of one or more suggested automobile parking locations, an indication of one or more suggested baggage drop-off locations, an indication of one or more user check-in locations, a current security wait time at one or more security check-points, an offer to view through the display screen associated with the electronic device at least one of an image or a video of a transportation departure location, a request to receive user feedback, an offer to receive transportation status updates, an offer to communicate with a customer service representative, or an offer to generate an image of a transportation boarding pass.

12. The method of claim 8, wherein the travel information comprises aircraft travel information.

13. The method of claim 8, wherein the one or more scheduled travel times is one or more first scheduled travel times, and wherein after generating, by the computing system for display on the display screen associated with the electronic device, the one or more travel notifications, the method further comprises:
receiving, by the computing system, subsequent travel information of the user account associated with the electronic device, wherein the subsequent travel information includes one or more second scheduled travel times;
determining, by the computing system, an updated location of the electronic device;
determining, by the computing system, an updated duration of time between a current time and the one or more second scheduled travel times; and
generating, by the computing system for display on the display screen associated with the electronic device, one or more new travel notifications based on the updated location of the electronic device, the updated duration of time, and the subsequent travel information.

14. The method of claim 13, wherein the one or more second scheduled travel times include at least one different scheduled travel time from the one or more first scheduled travel times.

15. A non-transitory, computer-readable storage medium storing one or more executable instructions that, when executed by at least one processor of an electronic device, cause the at least one processor to:
receive travel information of a user account associated with the electronic device, wherein the travel information includes one or more scheduled travel times;
determine a location of the electronic device;
determine a duration of time between a current time and the one or more scheduled travel times; and
generate, for display on a display screen associated with the electronic device, one or more travel notifications based on the location of the electronic device, the duration of time, and the travel information.

16. The non-transitory, computer-readable storage medium of claim 15, wherein the travel information further includes at least one of a user name, a user status, a user travel code, a user travel preference, a transportation identification, a departure location, an arrival location, a transportation boarding classification, or a baggage pick-up location.

17. The non-transitory, computer-readable storage medium of claim 15, wherein the one or more scheduled travel times include at least one of a transportation check-in time, a transportation boarding time, a transportation departure time, a transportation arrival time, or a transportation baggage pick-up time.

18. The non-transitory, computer-readable storage medium of claim 15, wherein the one or more travel notifications include at least one of a transportation status, an indication of a duration of time between the current time and a change of the transportation status, a recommended departure time from the location of the electronic device to a transportation departure location, an indication of a transportation departure location, an indication of one or more merchant locations between the location of the electronic device and a transportation departure location, an indication of a travel time from the location of the electronic device to one or more merchant locations, an indication of one or more baggage pick-up locations, an indication of a travel time from the location of the electronic device to one or more baggage pick-up locations, an indication of one or more suggested automobile parking locations, an indication of one or more suggested baggage drop-off locations, an indication of one or more user check-in locations, a current security wait time at one or more security check-points, an offer to view through the display screen associated with the electronic device at least one of an image or a video of a transportation departure location, a request to receive user feedback, an offer to receive transportation status updates, an offer to communicate with a customer service representative, or an offer to generate an image of a transportation boarding pass.

19. The non-transitory, computer-readable storage medium of claim 15, wherein the one or more scheduled travel times is one or more first scheduled travel times, and wherein, after generating the one or more travel notifications, the one or more executable instructions further cause the at least one processor to:
receive subsequent travel information of the user account associated with the electronic device, wherein the subsequent travel information includes one or more second scheduled travel times;
determine an updated location of the electronic device;
determine an updated duration of time between a current time and the one or more second scheduled travel times; and
generate, for display on the display screen associated with the electronic device, one or more new travel notifications based on the updated location of the electronic device, the updated duration of time, and the subsequent travel information.

20. The non-transitory, computer-readable storage medium of claim 19, wherein the one or more second scheduled travel times include at least one different scheduled travel time from the one or more first scheduled travel times.
